(19) United States
(12) Patent Application Publication
(10) Pub. No.: US 2025/0382201 A1
(43) Pub. Date: Dec. 18, 2025

(54) Systems and Methods for Adaptive Processing of Waste Streams

(71) Applicants: Barton Prideaux, Austin, TX (US); Warren Cody Armstrong, Port Aransas, TX (US)

(72) Inventors: Barton Prideaux, Austin, TX (US); Warren Cody Armstrong, Port Aransas, TX (US)

(21) Appl. No.: 19/231,896

(22) Filed: Jun. 9, 2025

Related U.S. Application Data
(60) Provisional application No. 63/658,886, filed on Jun. 12, 2024.

(51) Int. Cl. C02F 1/38; C02F 103/32

(52) U.S. Cl. CPC C02F 1/38; C02F 2103/32; C02F 2209/006

(57) ABSTRACT

A system for processing waste streams involving organic matter includes a first receiving facility that receives and executes a pre-processing operation on a waste stream to remove one or more types of solid objects in a waste stream; a centrifugal separator configured to separate solid materials remaining in the waste stream following the pre-processing operation from liquids in the waste stream; a solids recovery system that receives and stores separated solid materials; and a liquid recovery system that receives, stores, and processes the separated liquids. The liquid recovery system includes a liquid disposal system, and a liquid recycling system. The system for processing waste streams further includes a reuse system that receives the stored solid material and produces environmentally acceptable products by processing the solid materials.

### RELATED APPLICATIONS

This application claims the benefit of U.S. Provisional Application 63/658,886, filed Jun. 12, 2024, entitled “Systems and Methods for Adaptive Processing of Waste Streams.”

### BACKGROUND

Many manufacturing and production operations generate waste materials that require treatment and possible disposal. For example, the meat processing industry uses water extensively for washing food sources (e.g., fish, poultry, cattle, sheep, or pig carcasses). Water also is used for sanitizing and thoroughly cleaning all food processing equipment used in the food processing facility. A large quantity of water may be used to remove hair or feathers from animal carcasses. Federal regulations require a complete cleaning and sanitation after every animal killing and processing shift at a food processing facility. This cleanup generally uses considerably more water than the actual food processing.

All types of meat processes generate waste water with similar characteristics. They each contain high levels of total suspended solids (TSS), fats, oil, and grease (FOG), and other biologics, making disposal of waste stream components problematic. For example, some meat processing facilities discharge their waste streams to municipal sewage plants while other facilities discharge their waste streams directly to the environment, specifically into rivers and lakes. Discharges to municipalities pose many problems to municipal sewage plants, including, for example the inconsistent nature of meat and poultry processing plant flows, which makes it difficult for sewage plant operators to anticipate and plan for high-load waste stream flows.

Some current waste disposal systems and methods are directed to transforming waste streams into environmentally acceptable disposal; e.g., disposal of waste water in a river. However, some waste streams cannot be so transformed, and thus may require long-term storage. Current waste disposal systems often are purpose-built for a specific waste disposal operation, and are not readily adaptable to other waste streams. Current waste disposal systems are expensive to implement, expensive to operate, and expensive to maintain. State and Federal regulations evolve, placing more stringent requirements on waste disposal, and current waste disposal systems may not be acceptable without expensive modifications. Current waste disposal systems are manpower-intensive and may produce undesirable working conditions. Long-term waste storage solutions are expensive to implement and maintain, often requiring frequent monitoring and environmental reporting. Leakage from long-term waste storage tanks has been known to harm the environment, and in some instances, have made local areas around the tanks uninhabitable for humans and caused serious long-term, and sometime fatal illnesses.

Current waste disposal systems, even while meeting environmental disposal regulations for a part of a waste stream, frequently are left with a portion of the waste stream that cannot be disposed of in the environment. This remainder portion must be retained in an environmentally-acceptable storage facility; such a facility is expensive to maintain and operate, and are subject to the environmental risks noted above.

FIG. 1A illustrates a current (prior art) waste disposal system 10 that includes components of many current waste disposal systems. Such current waste disposal systems are used, for example, to dispose of waste liquid resulting from processing poultry, for example, to produce packed poultry products for human consumption. System 10 includes settling tanks 13 and 15, although one tank or more tanks could be employed based on the expected waste stream to be processed. Each tank 13 and 15 receives a solid/liquid mixture. In FIG. 1A, tank 13 includes a skimmer 12 that is employed to skim solids and foam off the liquid surface and a scrapper 14 employed to scrape solids that have settled from the liquid to the tank bottom. The skimmed and scraped materials may be transferred to solids storage tank 17. Liquids, which may carry some suspended solids, that remain in the tank 13 then may be transferred to a second tank 15, in which any remaining suspended solids are allowed to settle, and solids are skimmed and scrapped from the liquid surface and the tank bottom, respectively. These solids also are transferred to the solids tank 17. The solids then may be transferred to long term storage 20 or for disposal, for example, by truck. Liquid from tank 15, after skimming and scrapping, may be transferred to holding (liquid storage) tank 19, and various chemicals may be added to the stored liquid to make the stored liquid acceptable for environmental disposal. Once its chemistry is adjusted, the liquid may be disposed of, for example, by discharging 30 the liquid into a nearby river.

Waste disposal system 10 suffers from all the technological and operational challenges, drawbacks, and problems enumerated above. Perhaps most notable among these technological and operational deficiencies is the direct return of processed liquid to the environment by disposal in a nearby river (the need for such a convenient environmental dumping solution may explain why many poultry processing facilities are sited along rivers). Also notable is the need for long term storage of the separated solids.

FIG. 1B illustrates an alternate prior art waste disposal system for disposing of meat processing waste products generated by poultry and other meat processing facilities. In FIG. 1B, dissolved air flotation (DAF) system 50 uses dissolved air flotation to “pre-treat” a waste stream prior to transfer to a municipal sewage facility. The DAF system 50 injects microscopic air bubbles into a tank containing meat processing wastes. The air bubbles attach to certain waste solids, making them buoyant. The now buoyant waste solids float to the surface of a sludge tank/decanter, where the waste solids are removed by a skimmer. In FIG. 1B, receiver 51 receives a solid/liquid waste stream mixture from a meat processing plant. The mixture is pumped to wastewater tank 52 and air is provided from DAF unit 53. As solids float to the liquid surface in wastewater tank 52, the solids are removed by a skimmer (not shown) internal to the tank 52. The skimmed solids then are transferred to sludge tank/decanter 54 and processed water is transferred (pumped) to processed water tank 55. Sludge from the sludge tank/decanter is sent to sludge disposal and any decanted water is returned to wastewater tank 52. The processed water in tank 55 is treated with chemicals from chemical feed tank 56 so as to make the processed water acceptable for discharge to a municipal sewage system, with some amount of the processed water returned to the wastewater tank 52.

As is clear from the above description, the DAF process of system 50 suffers from many if not all the infirmities afflicting the waste stream disposal system 10 of FIG. 1A.

Another technological infirmity afflicting current waste processing facilities and corresponding operations, including those of FIGS. 1A and 1B is a rigid control process for executing the waste disposal (and, where implemented, recycling) operations. This rigidity of control stems at least in part by the fact that the facilities, systems, and operation rely on control features that are not capable of adaptation as the processing environment changes, Federal and State regulations evolve, and ever more capable hardware components are conceived of and put into operation, to say nothing of the ever-changing nature and composition of the waste streams to be processed. For example, considering the nature and composition of waste streams to be processed, some compositional variations may result in less than ideal or intended processing results, which may result in a processed waste stream that does not meet even minimal standards for environment discharge or long-term storage. The control features contributing to this rigidity often are preprogrammed controllers whose programming cannot be changed without major restructuring of the controllers, and in some cases, installation of new, more capable controllers that can support the increased program execution requirements needed to support updated programming. Thus, these existing implementations are basically static. Some waste disposal systems have attempted to address the static and rigid nature of their control systems by adopting programmable logic controllers (PLCs) that interface on the input side with specific components such as valves and pumps, and that interface on the output side with a central processing platform that may implement a Supervisory Control and Data Acquisition (SCADA) program. FIG. 1C (prior art) illustrates a typical PLC that may be implemented in the systems of FIGS. 1A and 1B. In FIG. 1C, PLC 60 employs power supply 61 to power scrape interface 63 and component interface 65. The two interfaces connect to processor unit 62, which includes processor 64, program memory 66A, data memory 66B, and serial port 68, to which a programming device 67 is coupled. The PLC 60 can provide fine control, but only to the limits of its programming. Thus, the PLC 60 is, in essence, inflexible, and further is incapable of “learning” in the sense that an artificial intelligence device may be trained to adapt to its environment.

### SUMMARY

Disclosed herein are improved waste disposal systems, and corresponding methods, that overcome the technical and operational deficiencies in current waste disposal systems. The herein disclosed adaptive waste stream processing systems are directed to disposal of wastes from processing animals, including fish, birds, mammals, and reptiles, and any other form of edible or nonedible animal. In a specific example, the systems are directed to animal processing that results in food products for human or animal consumption. In another specific example, the systems are directed to animal processing for uses other than making food products for human or animal consumption. The improved waste disposal systems make efficient waste disposal possible, are adaptable to multiple waste streams, may be largely automated, can be adapted to new environmental regulations, and provide a safe and comfortable environment for workers. Moreover, the improved waste disposal systems minimize residual waste materials by converting portions of the processed waste stream for alternate, environmentally-friendly uses, and recycling other portions of the processed waste stream.

An example waste disposal system is disclosed that may be used to process waste streams generated by food processing companies such as fish, poultry, cattle, pigs, and other meat producers. Taking the specific example of poultry processing (i.e., providing packaged food items from poultry such as chickens and turkeys), a waste disposal system may include a first stage waste processor, such as a clarifier, to remove certain solids in the waste stream so as to enable more efficient waste processing, and one or more second stage waste processors, with each second stage waste processor including one or more centrifugal separators. In an aspect, the second stage waste processor, or an additional stage, may include one or more vertical decanters that operate, in some respects similar to one principle of operation of the clarifier, namely that solids will eventually settle out (or in some case rise to the top) of a liquid volume. Some example vertical decanters may include internal rotating elements to enhance the separation process. In the second stage, the centrifugal separators may include one or more centrifugal decanters. When two or more centrifugal decanters are employed, the centrifugal decanters may operate in parallel or in series. The centrifugal decanters may be two-phase or three-phase centrifugal separators. The centrifugal separators also may include one or more two-phase or three-phase centrifuges. The one or more centrifuges may operate in series or in parallel with the centrifugal decanters, or with a vertical decanter. In some aspects of operation, the waste stream may be processed without a need for the centrifuges. Similarly, the centrifugal decanters may not be required in some operational scenarios. Thus, the system is designed to flexibly employ or bypass certain components based on a sensed makeup or composition of the waste stream as the waste stream is processed. The system further includes components that operate to produce an environmentally-acceptable product from solid wastes separated from the waste stream, and to recycle the liquid (i.e., processed water) separated from the waste stream. In an aspect, the solids are used in the production of organic fertilizer while the processed water is returned to the system, at various stages, to facilitate processing of the (continuous or near continuous) incoming waste stream. One skilled in the art will recognize that depending on the animal processed, and depending of the desired product from such processing, the herein disclosed waste stream disposal systems may require some modification. Nonetheless, the herein disclosed waste stream disposal systems generally are adaptable for any type of animal processing for any type of processed animal product.

A system for processing waste streams includes a waste stream processing system with multiple stages for separating solids in the waste stream from liquids in the waste stream. Thus, each of the multiple stages includes two-phase separation components, including decanters and centrifuges. The decanters may be static or centrifugal. The system may include a clarifier or similar component to remove certain solids before processing the waste stream in variable speed centrifuges. In an aspect, the system may be primarily manual or may be highly automated, and may include use of component sensors that feed data to a processing system that employs a large language model to control component operations based in part the sensor readings. Furthermore, the large language model may include an expert-configured feedback loop to train, in real-time, the large language model. The expert-configured system may include a human expert-machine interface, an unsupervised machine learning component, a supervised machine learning component, and a reinforcement machine learning component, all of which enable, or execute to train the large language model to improve the large language model's operational directives to (1) improve efficiency of waste disposal processing, (2) adapt waste disposal operations based on the specific composition of each incoming waste stream, (3) adapt reuse product operations to accommodate desired (and input) characteristics of reuse products, and (4) adapt waste disposal processing (within the limits of the existing waste system components) to comply with changing regulations or other requirements for waste disposal operations. In an aspect, the large language model may be trained and employed to alter waste stream operations based on desired characteristics of a reuse product, while still complying with all environmental and other regulations and requirements for waste stream processing, including the required final composition of the processed liquid (water). The expert-configured system may further include a rules engine, a rules database, a natural language processor, and a machine learning engine. The natural language processor may allow the expert system to “read” and assimilate data (text, numerals, images) provided in documents accessible to the expert system. As an example, a reuse product production document may include a listing of desired characteristics for a specific reuse product, such as fertilizer components. Furthermore, the large language model may interface with reuse product test components (automated or semi-automated) to measure reuse product characteristics from a completed batch of reuse products, create a block entry with the characteristics, date/time of production, location or origin (e.g., a specific waste processing plant) and when executed by a processor, upload these data to an immutable ledger so as to ensure/certify the integrity of the reuse product and make that certification available to entities (e.g., fertilizer manufacturers) acquiring the reuse product. Thus, the system provides raw materials certification to the supply chain.

A system for processing waste streams containing organic matter includes a first receiving facility that receives and executes a pre-processing operation on a waste stream to remove one or more types of solid objects in a waste stream; a centrifugal separator configured to separate solid materials, remaining in the waste stream following the pre-processing operation, from liquids in the waste stream; a solids recovery system that receives and stores separated solid materials; and a liquid recovery system that receives, stores, and processes the separated liquids. The liquid recovery system includes a liquid disposal system, and a liquid recycling system. The system for processing waste streams further includes a reuse system that receives the stored solid material and produces environmentally acceptable products (e.g., fertilizer) by processing the solid materials.

A system for processing waste streams containing organic matter includes an intake that executes a pre-processing operation on a waste stream to remove solids in a waste stream; a centrifugal separator stage that separates solids remaining in the waste stream from liquids in the waste stream following the pre-processing operation; a solids recovery system that stores separated solids separated; a component sensor system including one or more sensors that receive component operational data; a waste stream sampling system that collects and analyzes biological and chemical samples of the waste stream; and a processing system that executes machine instructions to configure the sensor system to sense component operational data based on an expected nature and composition of the waste stream, configure the sampling system to obtain chemical and biological samples of the waste stream based on the expected nature and composition of the waste stream, receive sensed component operational data and analyses of biological and chemical samples, generate a waste stream purification progress measure by applying sensed component operational data and analyses of the biological and chemical samples to a component operational plan that defines desired levels of waste stream purification, and process the waste stream until the desired level of waste stream purification is achieved, wherein the processor provides operation adjustments directly to individual components based on a measured progress toward the desired levels of waste stream purification.

### DESCRIPTION OF THE DRAWINGS

The detailed description refers to the following figures in which like numerals refer to like items, and in which:

FIGS. 1A and 1B illustrate typical current (prior art) waste stream disposal systems;

FIG. 1C illustrates a typical (prior art) programming logic circuit (PLC) that may be used with the systems of FIGS. 1A and 1B;

FIGS. 2A-2C illustrate example waste stream processing systems that overcome limitations inherent in current waste disposal systems;

FIG. 3 illustrates an example pre-processing component of the example waste stream processing systems of FIGS. 2A-2C;

FIG. 4 illustrates example liquid/solid separation components of the example waste stream processing systems of FIGS. 2A-2C;

FIGS. 5A-5C illustrate example vertical decanter components that may be incorporated into the example waste stream processing systems of FIGS. 2A-2C;

FIG. 6 illustrates an example centrifugal decanter that may be incorporated into the example waste stream processing systems of FIGS. 2A-2C;

FIG. 7 illustrates an example centrifuge that may be incorporated into the example waste stream processing systems of FIGS. 2A-2C;

FIG. 8 illustrates an example computer processing system that may be used to control operations of the example waste stream processing systems of FIGS. 2A-2C;

FIG. 9 illustrates an alternate control system that may be used to control operations of the of the example waste stream processing systems of FIGS. 2A-2C;

FIG. 10A illustrates an example code sequence executable by a processor of the example waste stream processing system to generate a prompt answerable by a large language model;

FIG. 10B illustrates example of components that interact with, train, and receive alerts from a large language model;

FIG. 11 illustrates aspects of an expert system that may be used with the example waste stream processing systems of FIGS. 2A-2C;

FIGS. 12A-12F illustrate example sensor and control components that may be used with the example waste stream processing systems of FIGS. 2A-2C;

FIG. 12G illustrates an example process for generating a model of the waste processing systems of FIGS. 2A-2C;

FIG. 13 illustrates an example implementation of a large language model executed by the processor system of FIG. 8 in conjunction with the example sensor and control components of FIGS. 12A-12F;

FIG. 14 illustrates an alternate sensor and component control system for use with the waste stream processing systems of FIGS. 2A-2C;

FIG. 15 illustrates a further alternate sensor and component control system for use with the waste stream processing systems of FIGS. 2A-2C;

FIGS. 16-20 are flowcharts illustrating example operations of the example waste stream processing systems and components of FIGS. 2A-12F;

FIG. 21 illustrates an example processed waste reuse system that may be used in cooperation with the example waste stream processing systems of FIGS. 2A-2C;

FIGS. 22 and 23 illustrate, respectively, an example supply chain and an example distributed ledger system that may be used with the example supply chain;

FIG. 24 illustrates an example operation of the processed waste reuse system of FIG. 21; and

FIG. 25 illustrates example operations using the supply chain of FIG. 22 and the distributed ledger of FIG. 23.

### DETAILED DESCRIPTION

The deficiencies, drawbacks, technical and operational limitations, inefficiencies and other aspects affecting acceptability of current waste disposal systems are detailed herein. To address all the limitations of current waste disposal systems, disclosed herein are systems, and corresponding methods, that (1) make possible efficient waste stream processing, (2) adapt to multiple different waste streams, (3) are largely automated, (4) are adaptable to changing environmental regulations and requirements, and (5) provide a safe and comfortable environment for workers. Moreover, the herein disclosed adaptive waste stream processing systems minimize residual waste materials by converting portions of a processed waste stream for alternate, environmentally-friendly uses, and by recycling other portions of the processed waste stream.

In an aspect, a system for adaptive processing of a waste stream of liquids and solids containing organic matter and non-organic matter includes a pre-processing stage with one or more pre-processing components configured to remove the solids from the waste stream; a centrifugal separator stage with one or more centrifuge components configured to separate remaining solids in the waste stream from liquids in the waste stream following the pre-processing stage; a component sensor system with one or more sensors configurable to receive component operational data from system components; a waste stream sampling system configurable to collect and analyze biological and chemical samples of the waste stream; and a processing system that includes one or more processors and a non-transitory, computer-readable storage medium having machine instructions encoded thereon, that the processor executes to configure the sensor system to sense component operational data based on an expected nature and composition of the waste stream, configure the sampling system to obtain and analyze biological and chemical samples of the waste stream based on the expected nature and composition of the waste stream, receive sensed component operational data and analyses of the biological and chemical samples, generate a waste stream purification progress measure toward a desired level of waste stream purification by applying sensed component operational data and the analyses of the biological and chemical samples to a control program, the control program defining the desired level of waste stream purification, and process the waste stream until the desired level of waste stream purification is achieved. The processor provides operation adjustments directly to individual components based on the purification progress measure. The control program includes local component control programs for one or more local components, each of which a local component control program that is generated and maintained by execution of a trained, large language model. The local component control program includes local component control instructions and a mapping of individual components of the system. The individual components include a control station, multiple individual waste stream processing and flow control components, component sensors for one or more of the individual components, and one or more sampling stations. The individual components include a small, or local, processing unit. The local processing unit includes a local processor and the local component control program. The local processing unit is configured for two-way communication with the control station. The local processing unit receives sensed data from an associated local component, processes the sensed data, adjusts operation of the associated local component based on the sensed data and the local component control program, and provides operational adjustments and sensed data to the control station.

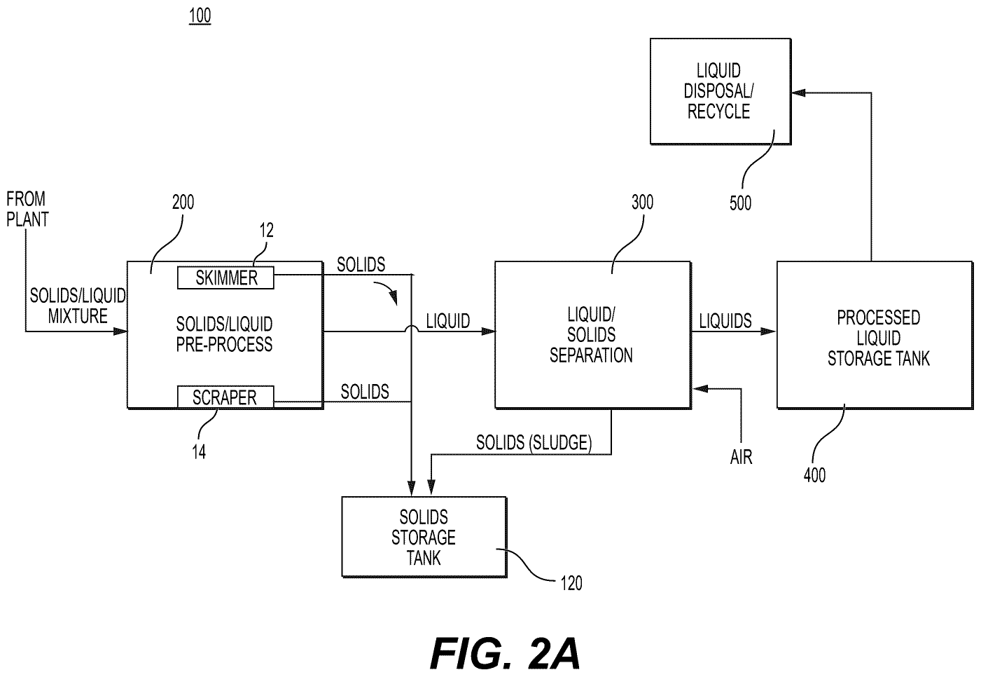

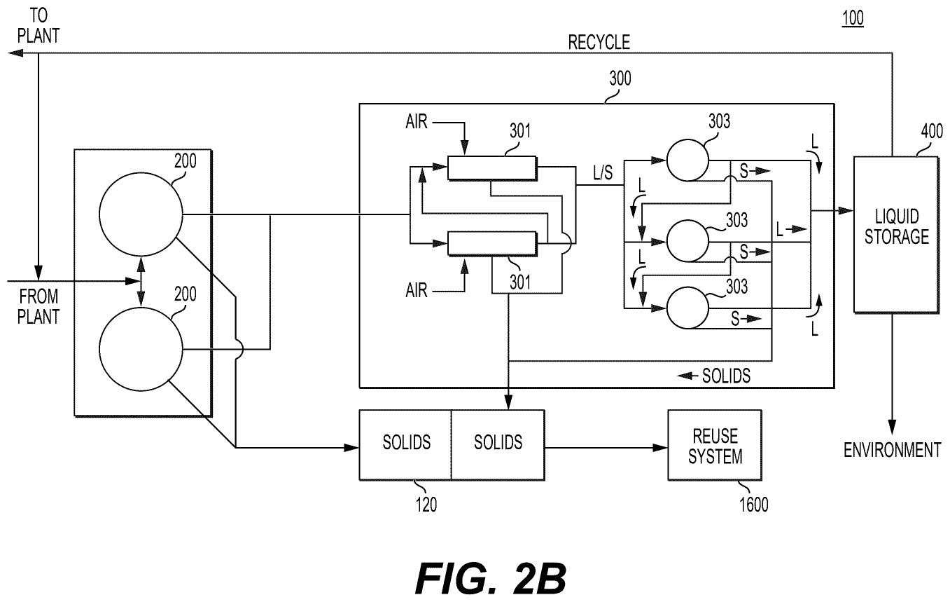

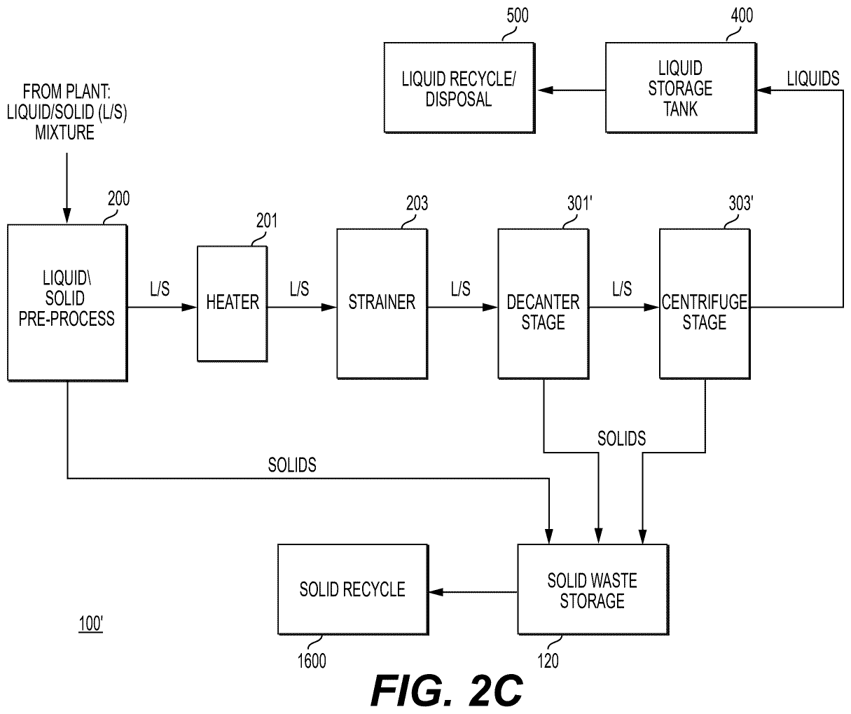

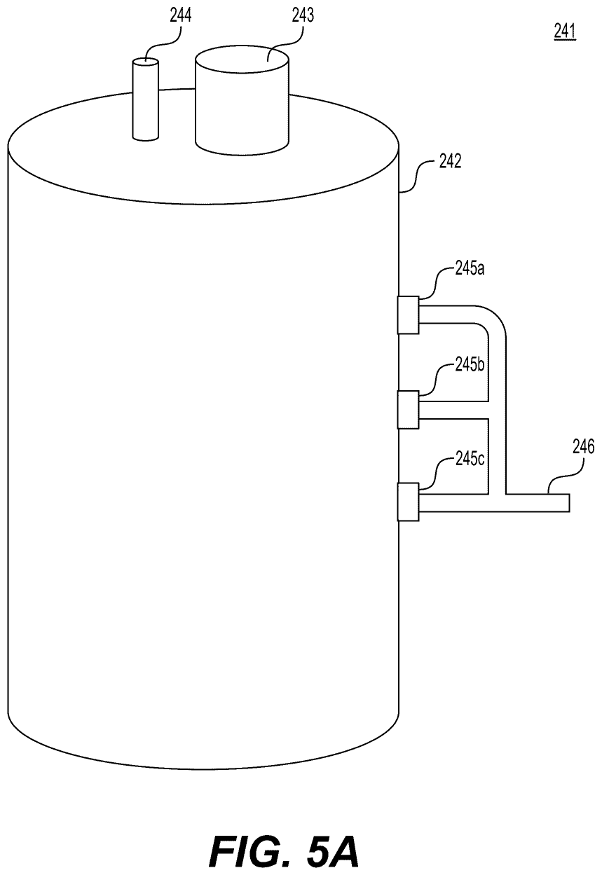

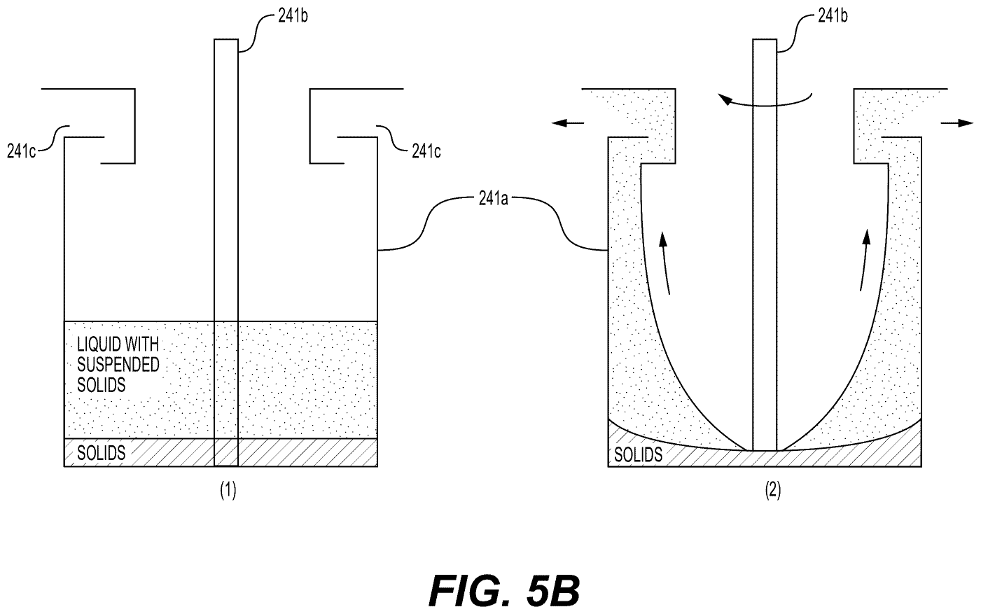

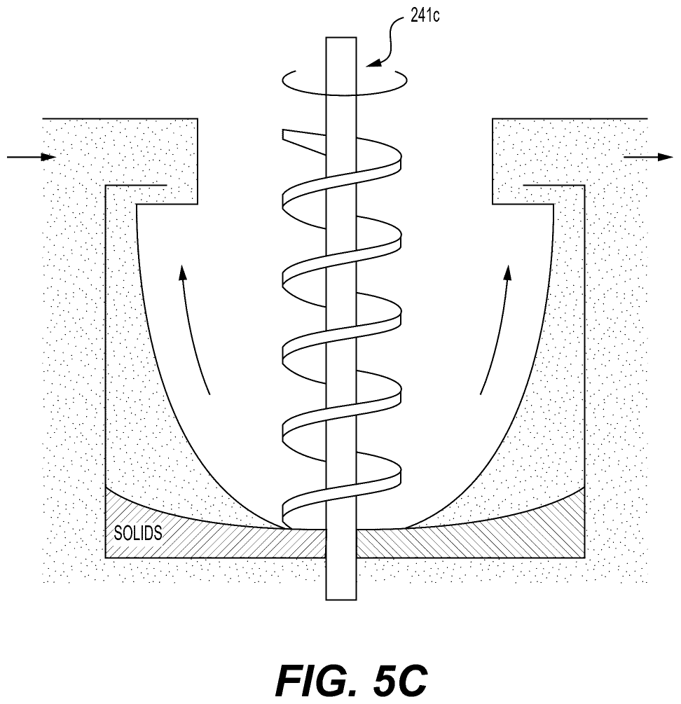

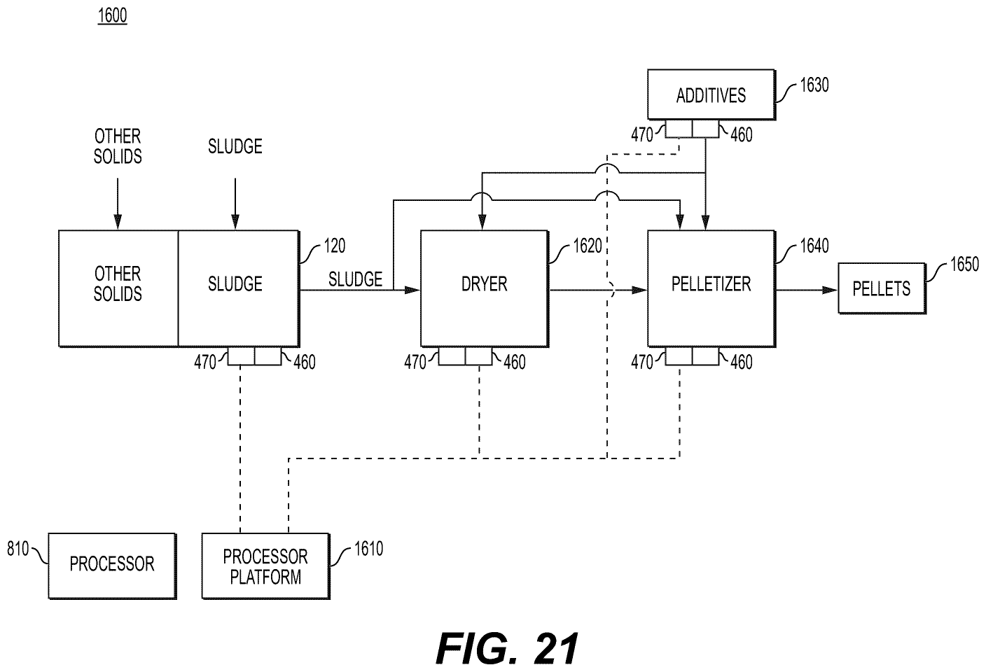

FIG. 2A is a block diagram illustrating an example adaptive waste stream processing system. In FIG. 2A, waste stream processing system 100 includes multiple stages of waste stream processing beginning with waste stream separation. A first stage for waste stream separation receives a solid/liquid waste stream and operates to perform a solids/liquids separation process to remove certain solids, including solids that may not be safe to process in subsequent stages of the system 100. The waste stream may be pumped from a preceding holding tank, or directly from a product processing/manufacturing plant or facility. In an example, the product is human-edible food stuffs, and more particularly, packaged poultry such as chicken and turkey meat, and the waste stream includes the poultry remnants, which may be animal solids and liquids in a liquid such as water. The consistency of this solid/liquid waste stream may vary. Optional solids/liquid pre-processing tank 200 receives the waste stream, and through a process of scrapping using scrapper 14 and skimming using skimmer 12, some solids are removed from the liquid/solid mixture. The removed solids may be transported to solids storage tank 120. Liquid remaining in the intake tank 200 then may be pumped to liquid/solids separation stage 300. Rather than, or in addition to, the intake tank 200, the waste processing system 100 may employ one or more automatically controlled strainers (not shown). Liquid in the liquid/solids separation stage 300 may be processed by passing the liquid through one or more centrifugal separation stages. Each such centrifugal separation stage may employ a two-phase separator (i.e., a separator that separates solids from liquids-see FIGS. 5A-7). In an aspect, air may be introduced to one or more of the two-phase separators to at least partially dry the separated solids. Following processing in liquid/solids separation stage 300, solids are transferred to solids storage tank 120 and liquids are moved to a processed liquid storage tank 400. While in tank 400, the liquid may be sampled for various characteristics including total suspended solids, clarity, pH, bacteria count, and other characteristics. If the liquid is acceptable for disposal, the liquid may be transferred a system for liquid recycling and/or disposal 500 for disposal and optionally some liquid may be retained for recycling. After solids are stored in solids storage tank 120, the solids may be transferred to a recycling or reuse system 1600 (see FIG. 21). Having the waste system processing system 100 as an integral element of a food (e.g., poultry) processing facility makes waste stream treatment and waste disposal more efficient and economical. Furthermore, government regulations mandate that a food processing facility be cleaned after each “shift” of food processing. Cleaning a food processing facility requires access to large quantities of clean water.

The U.S. Department of Agriculture (USDA) classifies areas of a meat and poultry plant (MPP) as edible product areas and inedible product areas, and allows recycled water to be used for cleaning edible product areas only if the recycled water (1) meets all requirements for potable water, and (2) is approved for such use. To meet potable water standards, the recycled water must meet all applicable EPA National Primary Drinking Water Regulations for chemical, microbial, and physical parameters (e.g., no detectable coliforms, acceptable turbidity, etc.). To be “approved”, the MPP must receive approval from USDA's Food Safety and Inspection Service. FSIS approval entails submitting detailed water treatment plans, Oroviding water test results showing compliance with potable water standards, and demonstrating control measures to prevent recontamination. More specifically, FSIS approval requires an initial and a continued demonstration of no risk of product adulteration. That is, use of recycled water in edible product areas does not (1) contaminate meat or poultry products, (2) create insanitary conditions, and (3) cause adulteration within the meaning of the Federal Meat Inspection Act (FMIA) or Poultry Products Inspection Act (PPIA). To maintain FSIS certification, the MPP must provide documented monitoring and verification including regular water testing, maintenance of logs, and documented compliance with applicable microbial and chemical thresholds.

FIG. 2B is a top view of the waste stream processing system 100 showing alternate tank, separation, and connection options. For example, the system 100 is shown to include two centrifugal decanters 301. The system 100 may be controlled such that the inputs to the decanters 301 are arranged in series or in parallel. In addition, the outputs may be arranged in series or in parallel. Furthermore, while two decanters 301 are shown, more or fewer decanters 301 may be employed. Similar arrangements exist for the tanks 200 and the centrifuges 303. Finally, while not shown in FIG. 2B, the system 100 may employ a vertical decanter such as the vertical decanter 241 of FIG. 5A.

FIG. 2C shows another waste stream processing system 100′, with additional components such as inter-stage heaters and strainers. Waste stream processing system 100′ receives a liquid/solids (L/S) mixture from a food processing facility, where the mixture enters solid/liquid pre-processing intake tank 200, moves to heater 201 and then to strainer 203. These first three components remove solids from the mixture and the removed solids may be sent to solids storage tank 120. Following strainer 203, the mixture passes through decanter stage 301′ and centrifuge stage 303′, and solids are transferred to solids storage tank 120. Liquids are transferred to liquid storage tank 400 and from there to a tank or system for liquid recycling and/or disposal 500.

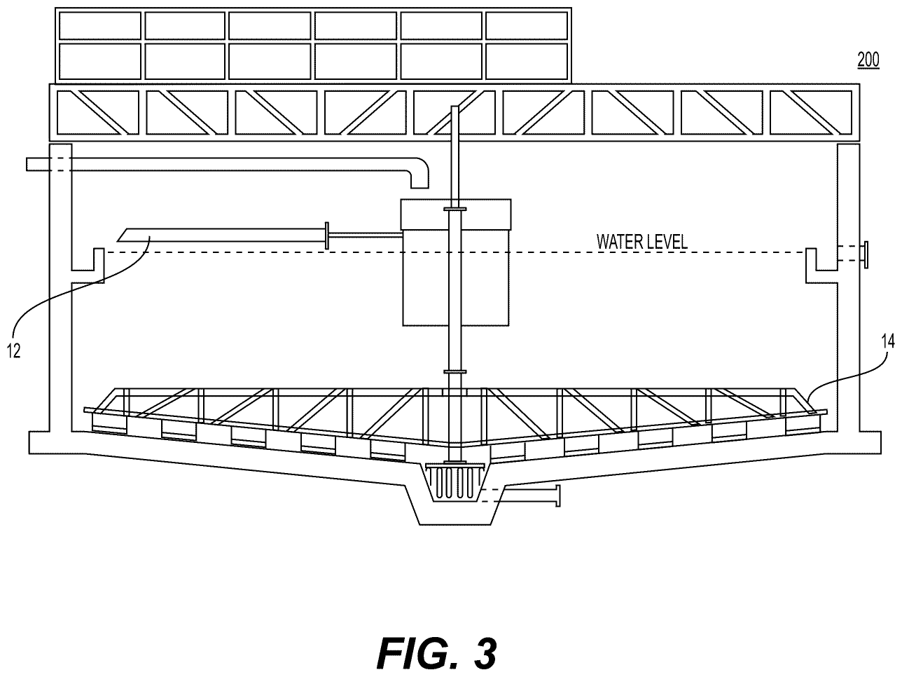

FIG. 3 illustrates example intake (pre-processing) tank 200. Intake tank 200 is optional and may not be required for some waste stream processing. As shown in the example of FIG. 3, intake tank 200 includes a centrally-driven skimmer 12 and a centrally-driven scraper 14. When processing wastes streams from poultry production, for example, the skimmer 12 removes solids such as feathers that rise to the top of the water, and the scrapper 14 removes solids such as bones and sludge that settle to the tank bottom.

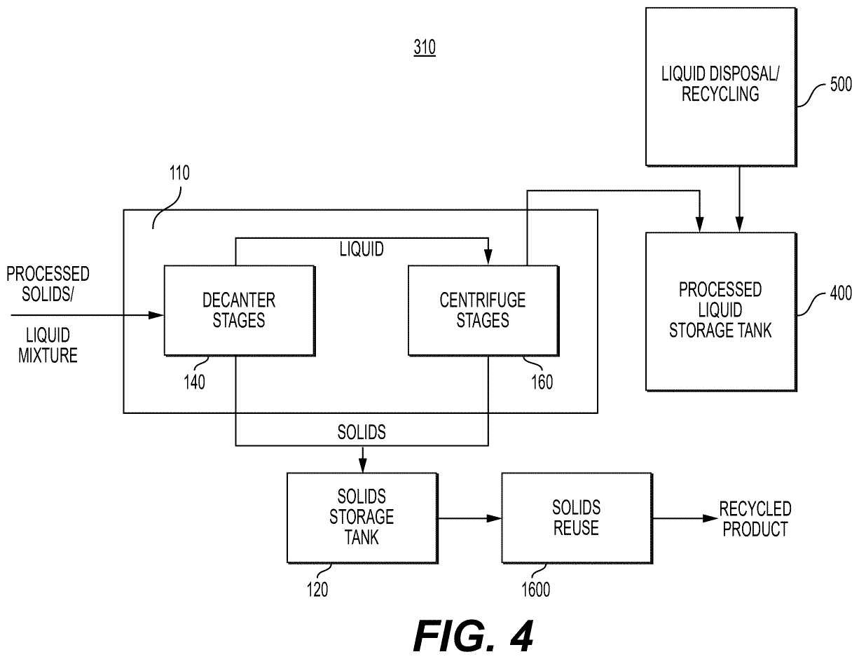

FIG. 4 is a block diagram illustrating liquid/solids separation components of the system 100 of FIG. 2A. In FIG. 4, liquid/solid separation components 310 include centrifugal stages 110, and in particular, decanter stages 140 and centrifuge stages 160. The decanter stages 140 may receive a processed solids/liquid mixture and may continue solids separation, with separated solids transported for storage in solids storage tank 120 and for possible recycling in solids reuse system 1600. Liquids (which may still have suspended solids) from the decanter stages 140 are transported to centrifuge stages 160 for further solids separation. Liquids from the centrifuge stages are transported to processed liquid storage tank 400 and eventually the tank or system for liquid recycling and/or disposal 500.

FIG. 5A illustrates a vertical decanter that may be employed in the system 100 of FIG. 2A. In FIG. 5A, vertical decanter 241 includes tank 242 having an interior center portion (not shown) rotated by electric motor 243. A solid/liquid mixture may enter the tank 242 at its bottom. Clean water may be supplied through connection 244. Heavier material (e.g., solids) will, over time, settle to the tank bottom. To speed the process, the interior center portion may be rotated, which causes heavier material to move to the inner surface of a center cylinder or bowl (see FIG. 5B) of the tank 242. The liquids in the tank 242 will rise up in the tank interior because of displacement by the solids (and also any heavier liquids), and by centrifugal force. A series of take-off connections 245a, 245b, and 245c culminating in drain 246 are provided on the tank 242, with a specific take-off for different liquid levels in the tank 242.

FIG. 5B is a cross section view of the vertical decanter 241 showing one configuration of the inner cylinder or inner bowl 241a and a corresponding internal rotation mechanism 241b that enhance liquid/solid separation. As can be seen in FIG. 5B, rotation of the inner bowl 241a causes solids to move to the sides of the inner bowl 241a and causes liquids (e.g., water), being less dense than some solids, to not only move to the sides of the inner bowl 241a, but also to escape the inner bowl 241a (and the tank 242) through ejection ports 241c, and ultimately the take-off connections 245a-245c. Accumulated solids may be removed in a batch operation with the inner bowl 241a stationary.

FIG. 5C is a cross-section view of the vertical decanter 241 showing an alternative configuration of the inner bowl 241a. In FIG. 5C, inner bowl 241a is equipped with a co-axial auger/internal rotation mechanism 241d. The internal rotation portion is used to spin or rotate the inner bowl 241a; however, the auger portion is configured to rotate at a speed that is different from that of the inner bowl 241a. For example, the auger portion may be geared to rotate at a slightly slower speed than the inner bowl 241a. The differential rotation speeds allow the auger portion to continuously remove solids from the inner bowl 241a. Solids scrapped by the auger portion may be removed through a discharge port (not shown) located in the top closure of the vertical decanter 241.

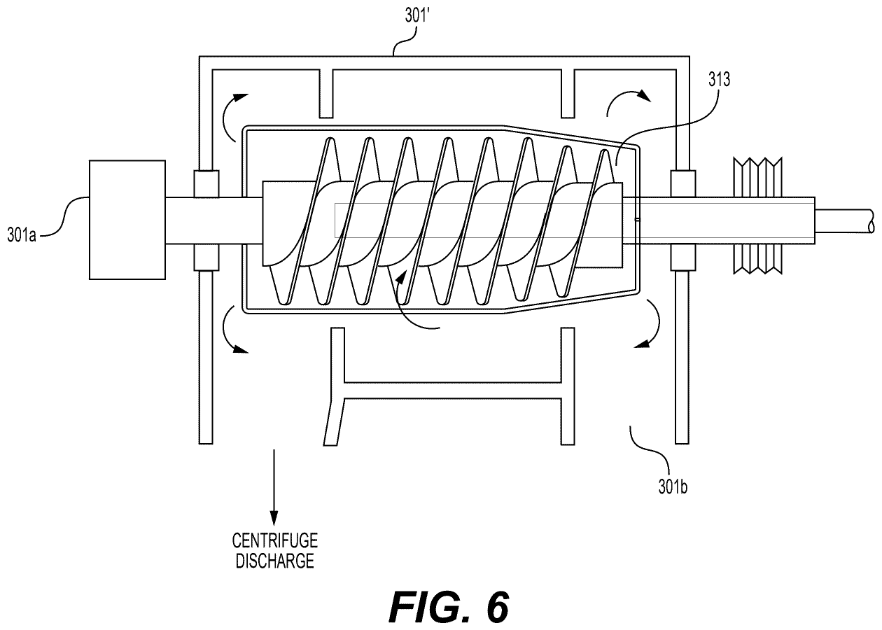

FIG. 6 is a cross-sectional view of an example centrifugal decanter (or decanter centrifuge) that may be used with a first sub-stage of a centrifugal separation stage. As can be seen, centrifugal decanter 301A includes a helical screw rotor 313, driven by motor 301a, that advances sludge from a liquid/solid inlet (not shown) to a discharge port 301b. Although not shown in FIG. 6, the centrifugal decanter 301A may be provided with a compressed air flow (not shown) at the discharge port 301b to further dry the accumulating sludge before the sludge is recycled or dumped.

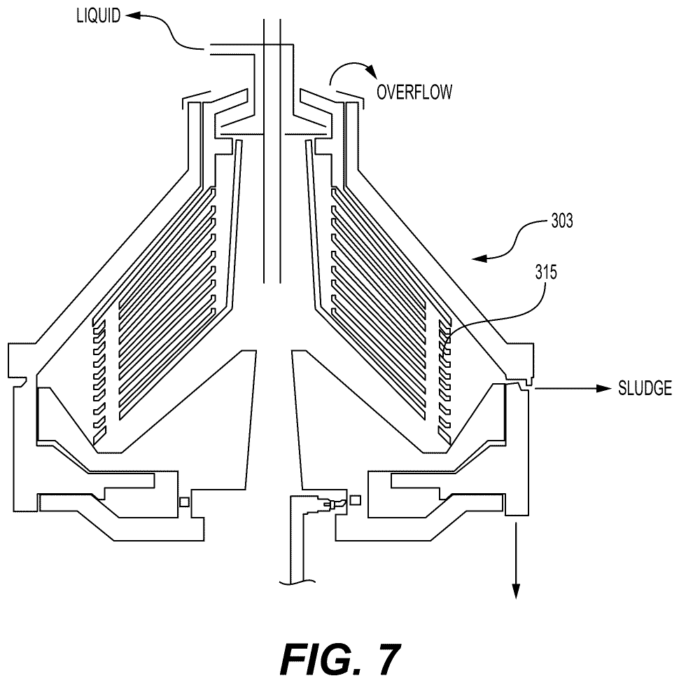

FIG. 7 illustrates an example centrifuge that may be used with a second sub-stage of the centrifugal separation stage. Example centrifuge 303 is a bowl centrifuge with stacked discs 315 that facilitate solids removal from liquids lying between the discs 315.

Use of both centrifugal decanters 301A and centrifuges 303 in a series operation allows the centrifugal decanters 301A to remove sludge while spinning at a slow speed and the centrifuges 303 to remove remaining sludge while spinning at a higher speed, without damaging either component. For example, the centrifugal decanters 301A may spin at 3000 rpm while the centrifuges 303 spin at 5000 rpm or more.

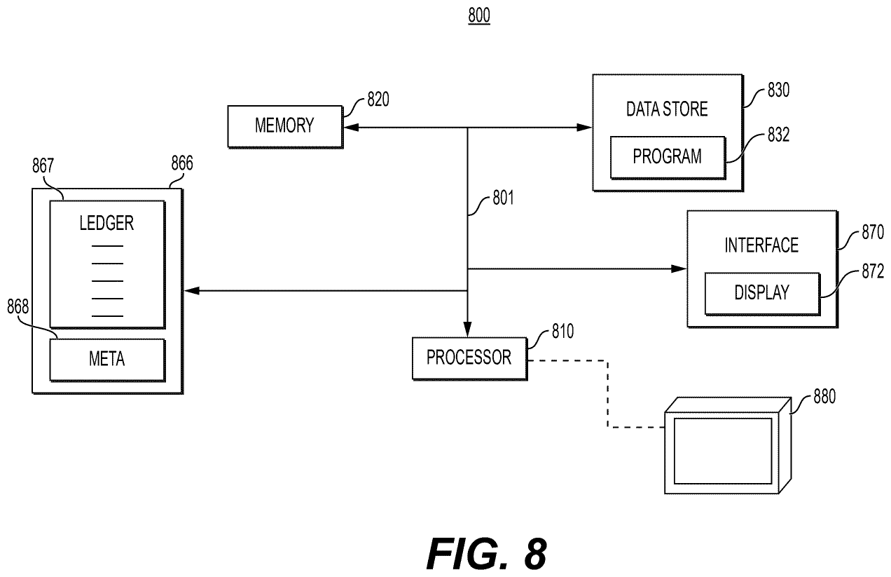

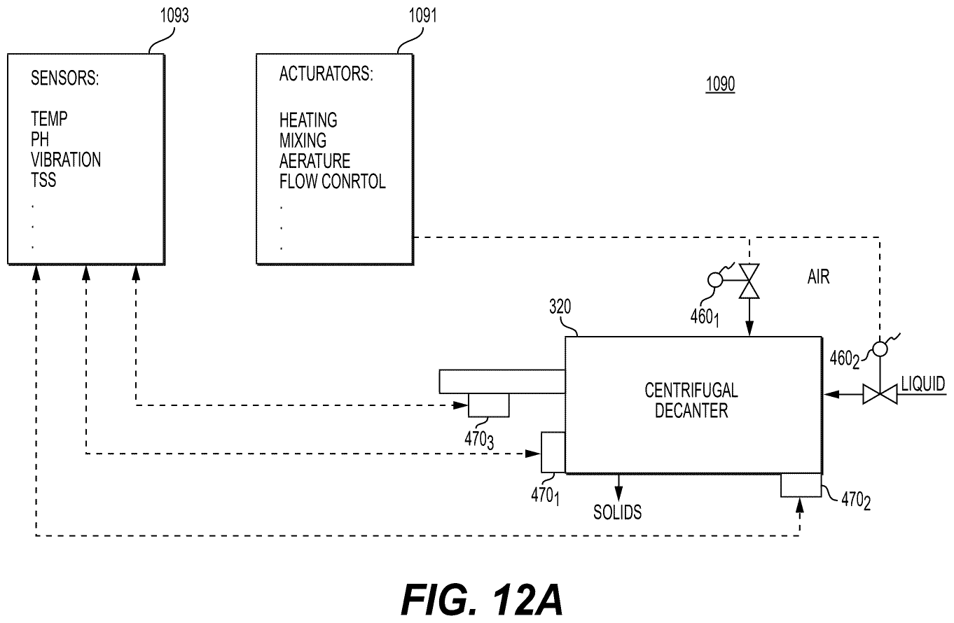

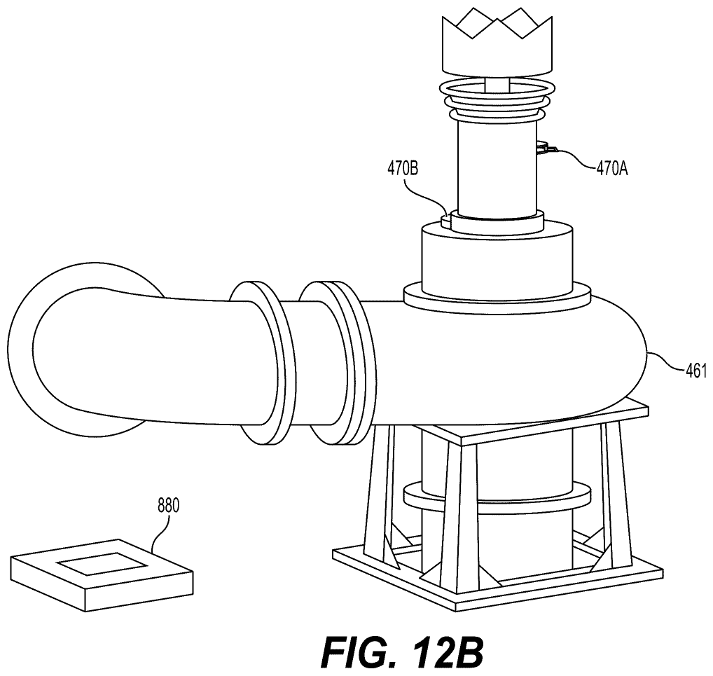

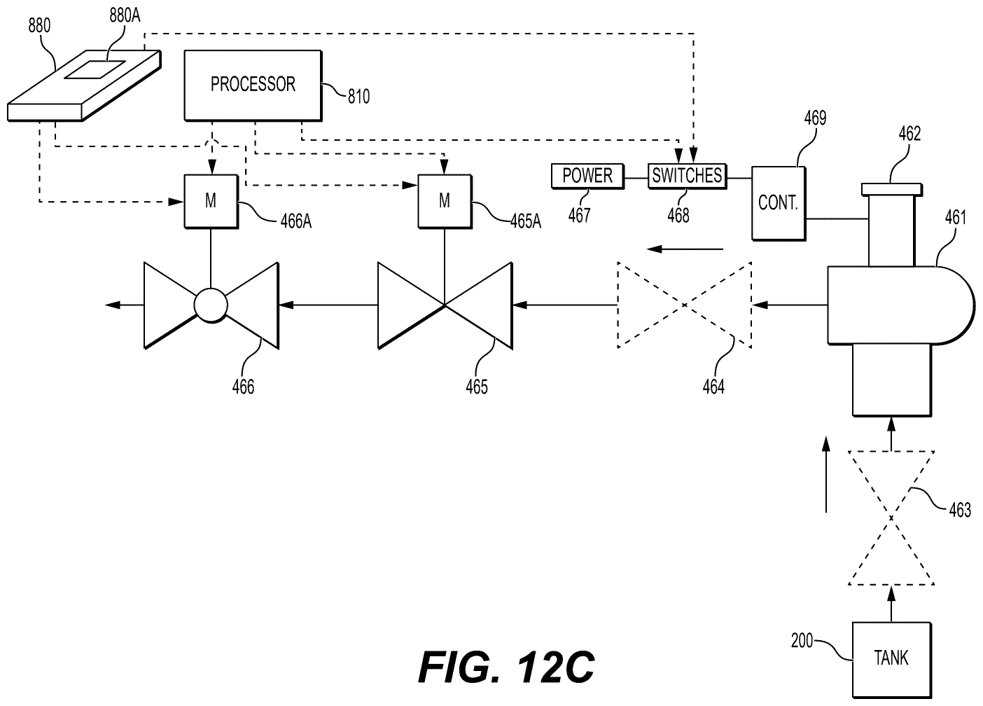

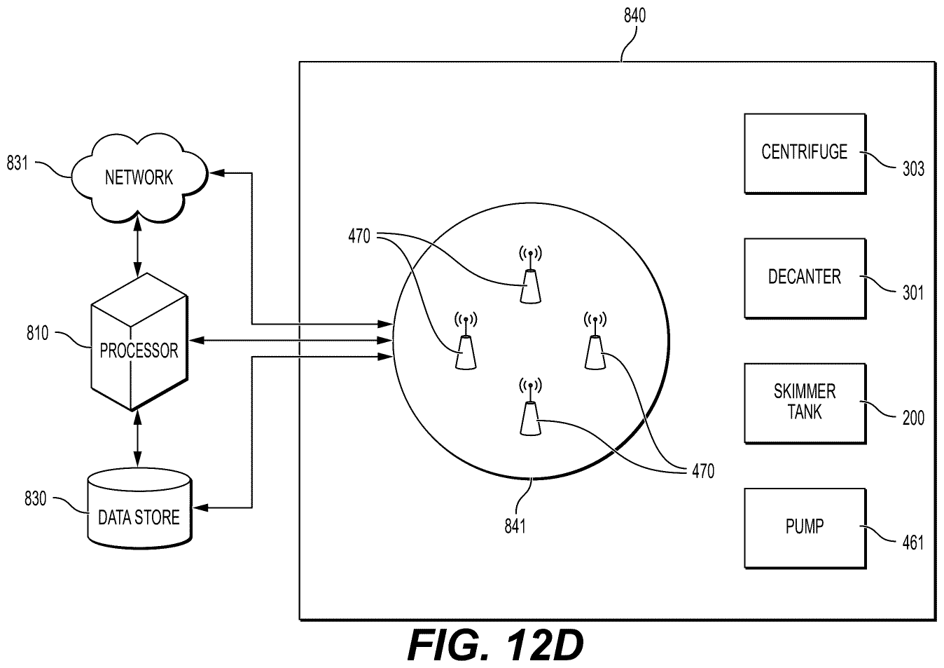

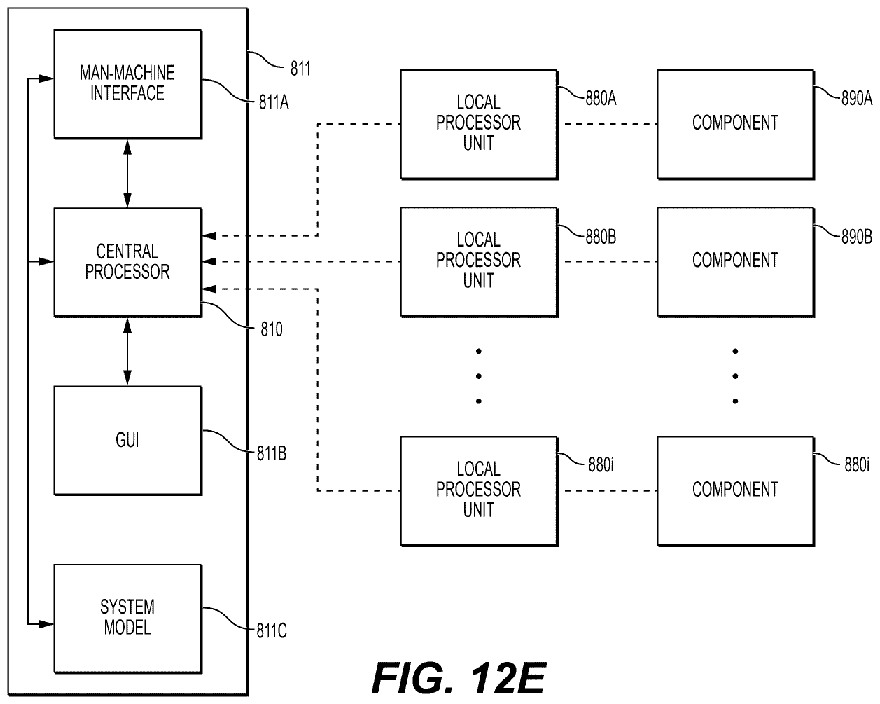

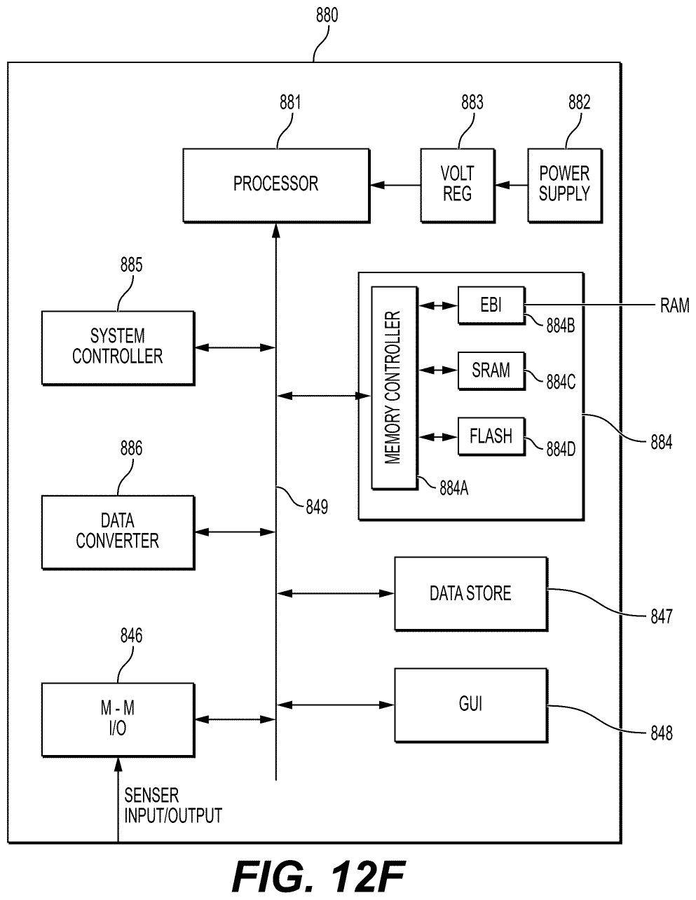

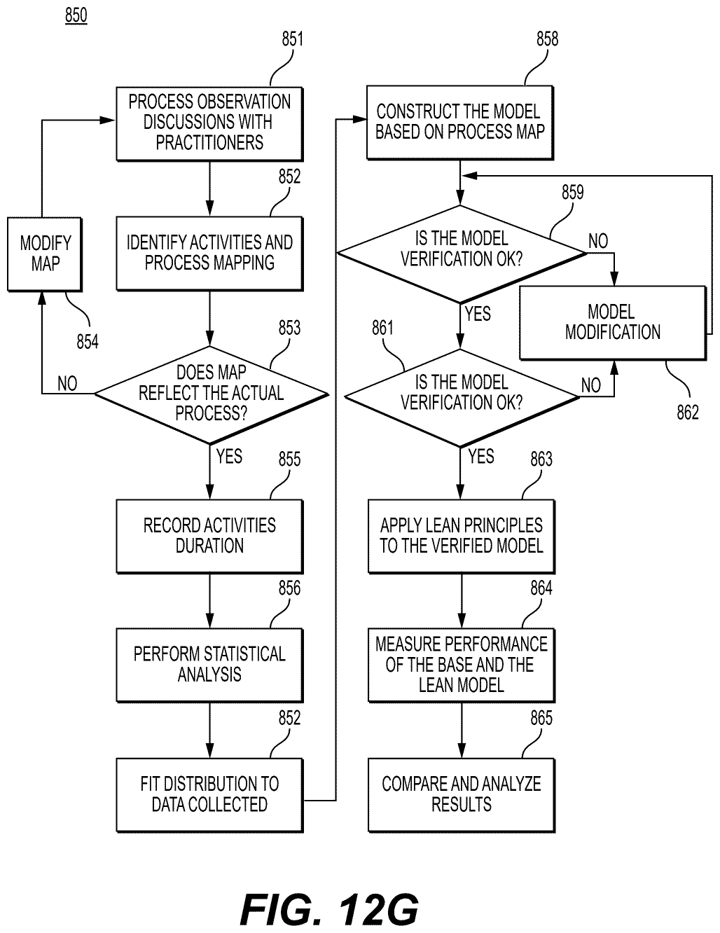

The waste stream processing system 100 may be controlled using different mechanical, electrical, and computer (processor) options. A mostly remote operation is made possible using properly and specially programmed processors. FIG. 8 illustrates a processor system that allows essentially fully remote operation of the system 100. In FIG. 8, processor system 800 includes one or more processors 810, memory 820, data store 830, which is, or which includes, non-transitory, computer-readable storage media having encoded thereon a program 832 for controlling operation of the system 100. In an example, the program 832 may include a large language model, programs for training the large language model, and a waste stream processing system operation control program that is executed by one or more processors to purify or otherwise process a waste stream emanating from a food processing facility. As disclosed herein, the waste stream processing operation control program (or, simply operation control program) may be an LLM-based program, or an LLM-based agent. In an aspect, the LLM-based program may reside solely at a central processor (e.g., processor 810) of the waste stream processing system. In another aspect, elements of the LLM-based agent may be distributed to a network of local processing units, with individual local processing units (e.g., local processing units 880) configured to monitor and control operations at certain waste stream processing components. For example, a single local processing unit 880 may be configured to monitor and control operations of centrifuges, sampling stations, valves, and sensors that are encompassed by the centrifuges 303 of FIG. 2B or the centrifuge stages 160 of FIG. 4. Also shown in FIG. 8 is a distributed ledger system 866 implementing an immutable ledger (e.g., a blockchain) 867. Individual entries in the immutable ledger 867 may reference metadata 868 associated with the entries. Certain entries in the immutable ledger 867 may employ smart contracts, or similar programming. The smart contracts may include programming that is executable to receive and store data from operation of the system 100. The smart contracts, in conjunction with other data obtained during operation of the system 100, may be used to guarantee the provenance and quality of recycled products produced by the reuse system 1600 (see FIG. 21). In an aspect, the program 832 may include a large language model that learns the operational requirements of the system 100, and is executed to generate an operational control program that in turn, is used to automate system operation, or, alternatively, to provide semi-automatic control. Finally, interface 870 provides a man-machine interface to allow experts and operators to interact with the system 100, to receive (over display 872) data and information related to system operation, to train the large language model, and to take manual or semi-automatic control of the system 100 when automated control is not desired, required, or feasible. The components of the processing system 800 communicate over information and data bus 801. The processors 810 may communicate with the system 100 using wired or wireless communications. In an aspect, the processors 810 may communicate with (small, portable or fixed) local processing unit 880, examples of which are shown in FIG. 12E and 12F. In a further aspect, as noted above, some or all local processing units 880 may include an LLM-based local control program, to sense, control, and report on operations at a specific local component or component stage.

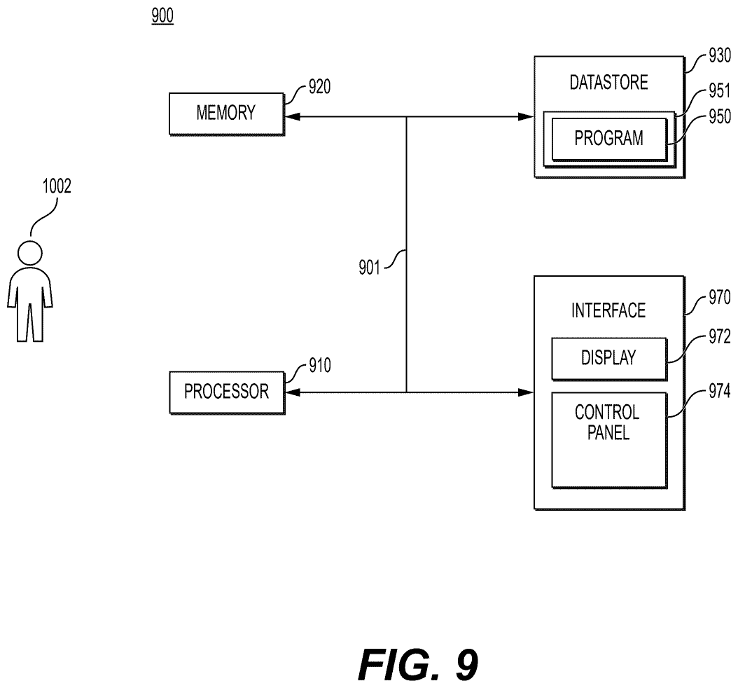

FIG. 9 illustrates an alternative processing and control system for the waste stream processing system 100. In FIG. 9, system 900 includes processor 910 in communication over communications bus 901 with memory 920, data store 930, and interface 970. Data store 930 includes program 950, stored on non-transitory, computer-readable storage medium 951 as machine executable code. Interface 970 includes display 972 and control panel 974 (which may be a “soft key” panel). An operator 1002 may control operation of the system 100 through activation of various soft keys on control panel 974. For example, operator 1002 may start and stop machines, control machine operation (e.g., adjust rpm), operate solenoid-and motor-operated valves, and conduct other operations including sampling and analysis. The program 950, in addition to communicating between control panel 974 and waste stream processing system 100, may activate automatic controls in certain situations. For example, the program 950 may be executed to shut down a centrifuge 303 should sensed vibration exceed a control limit. Furthermore, the system 900 may be paired with the system 800 so that the system 100, and its components, may be operated under control of operator 1002 at panel 974, or under control of the large language model-trained control program, local processing units 880, and processor system 800. When combined, a single processor (e.g., processor 810 or processor 910) may provide computer controls for processing system 900 as well as processing system 800.

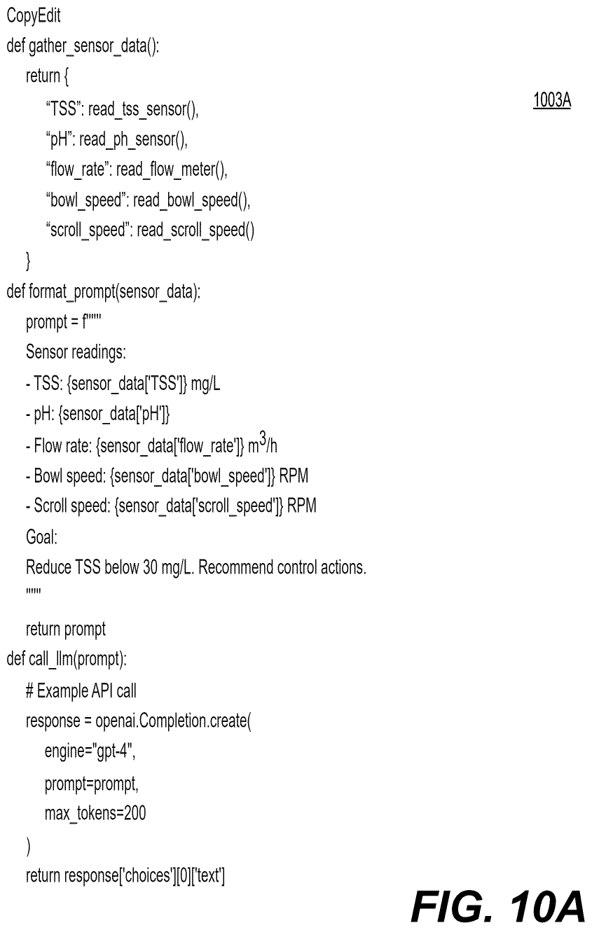

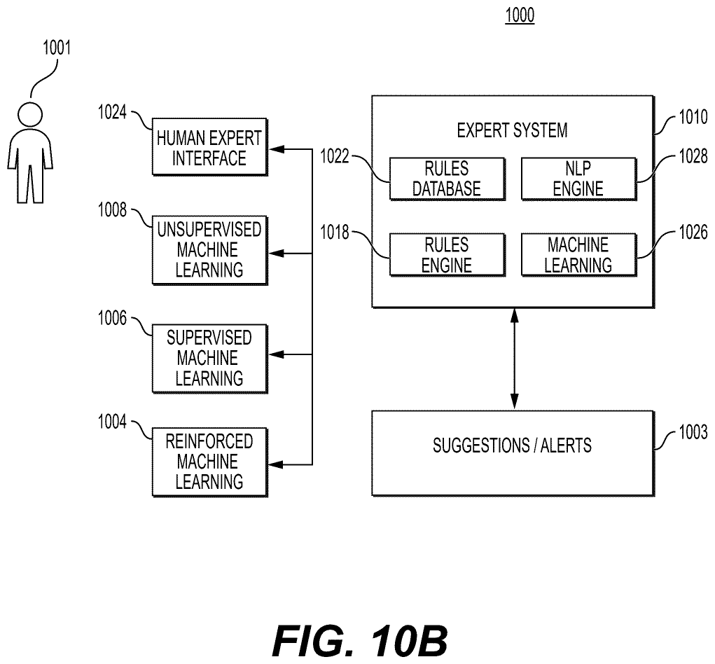

FIG. 10B illustrates examples of components that interact with, train, and receive alerts from the large language model-trained control program. In FIG. 10B, control system 1000 utilizes a human expert interface 1024 (e.g., a graphical user interface (GUI)). A human expert 1001 may operate and receive information through the human expert interface 1024. The human expert interface 1024 may be operated to implement various actions, including operating a natural language processor (NLP), which is part of NLP engine 1028. Control system 1000 includes an unsupervised machine-learning module 1008. The unsupervised machine-learning module 1008 that may be used to allow the NLP engine 1028 and the large language model to learn new words/phrases; learn new machine data and sensor data patterns; etc. Control system 1000 includes supervised machine-learning module 1006. The supervised machine-learning module 1006 may refine words/phrases, implement NLP models, etc. Control system 1000 includes reinforcement machine-learning module 1004. The reinforcement machine-learning module 1004 may refine words/phrases, implement NLP models, and determine operational patterns of system components, for example. The control system 1000 also may be used to construct and test a model (see FIG. 12G) of the waste stream processing system 100, including all relevant components, principles of component operation, and data consumed by and data produced by the waste stream processing system 100.

Large language model components of control system 1000 also include expert system 1010 shown in FIG. 10B. Expert system 1010 is used to initially train, and then re-train, the large language model. Expert system 1010 includes NLP engine 1028, rules database 1021, rules engine 1018, and machine learning module 1026. Finally, the expert system 1010, using, for example, the NLP engine 1028, may generate suggestions and alerts 1003 related to operation of the system 100.

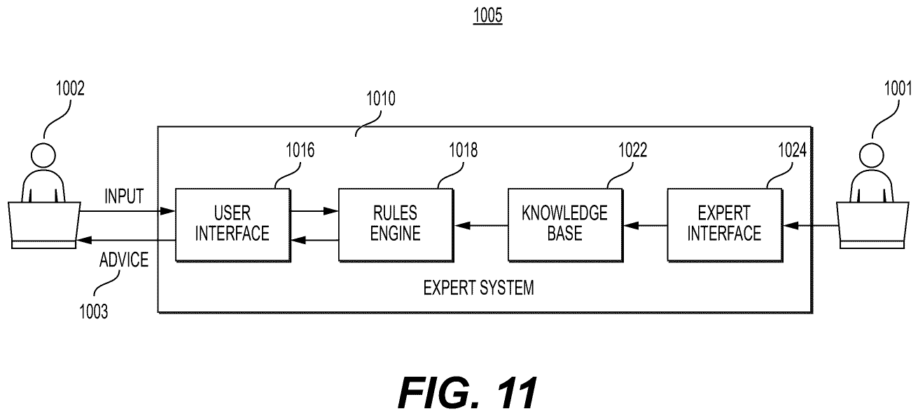

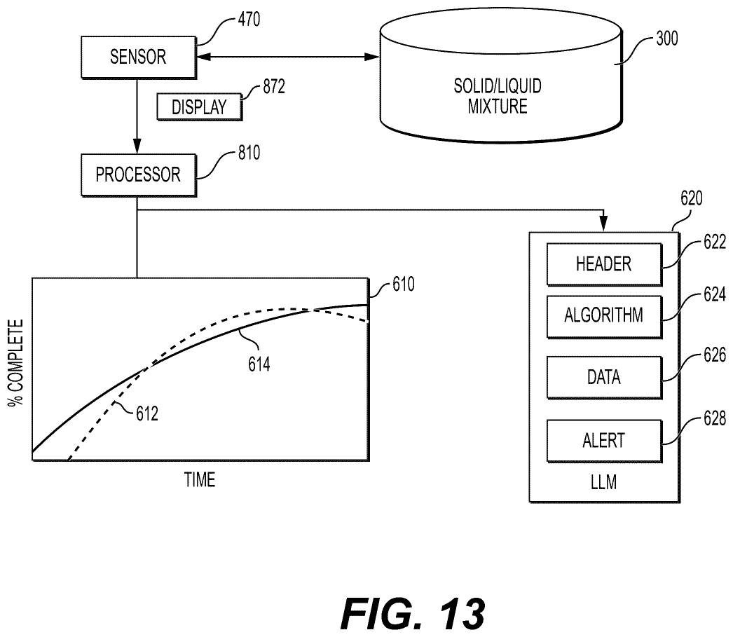

FIG. 10A illustrates an example code sequence executable by a processor of the example waste stream processing system 100 to generate a prompt answerable by the large language model 620 of FIG. 13. In FIG. 10A, code sequence 1003A includes a prompt directing the LLM 620 to recommend control actions for the vertical decanter 241 of FIG. 5C to reduce total suspended solids (TSS) to less than 30 mg/L. The processor 810, or alternatively a local processor unit 880i, then applies the code sequence 1003A to the LLM 620 to generate either a control action to alter operation of the decanter 241 or advice or alerts to a human operator 1002 (see FIG. 11) as to the action to be taken to achieve the desired TSS value. In an aspect, the control system 1000 may maintain a library of prompts to be called by a central processor or local processors and applied by these processors to LLM 620. Furthermore, the control system 1000 may generate new prompts as circumstances demand and may revise existing prompts when necessary.

FIG. 11 presents an example information flow 1005 illustrating transmission of expert information from expert 1001 through expert interface 1024 to operator 1002 by way of user interface 1016 (e.g., interface 870). Between the interfaces, the expert system 1010 includes a knowledge base 1022 and a rules engine 1018. The knowledge base 1022 may include historical data (machinery logs, sensor logs, sample results from operation of the waste stream processing system); outside sources such as industry standards, regulations, lessons learned, professional publications; and other data. The rules engine 1018 may specify what actions the waste stream processing system should take in response to sensed data.

In an aspect, the large language model, which cooperates with a control program, is trained using the features and concepts disclosed in FIGS. 10A, 10B, and 11 so as to be able, in accessing historical data, near real-time data, and, in some instances, real-time data, to interpret the data (e.g., interpret sensor logs), generate and optimize control scripts (e.g., local component control programs), interface with the local processing units in communication with local components such as vertical decanter 241 of FIG. 5A, and its associated sensing and sampling devices, isolation and flow control valves, and other controllable mechanisms; and provide anomaly detection, trend analysis, system and component diagnostics, and directions for control of the associated local components. Thus, a large language model such as the LLM 620 of FIG. 13 is able, in conjunction with the program 832 of FIG. 8, to provide automated or semi-automated sensing, analysis, and control of the herein disclosed waste stream processing systems. That is, the program 832, which is designed and written to maximize efficiency of waste stream processing operations while complying with safety requirements and various regulations, cooperates with LLM 620. In essence, control program 832 is an LLM-based control program. Furthermore, the LLM-based control program 832 may be formed of many individual LLM-based component control programs, with each individual LLM-based component control program configured to control operations of a corresponding individual component such as a vertical decanter.

FIG. 12A illustrates an example actuator/sensor system that may be employed with the systems of FIGS. 2A-2C. In FIG. 12A, actuator/sensor system 1090 includes actuator subsystem 1091 including actuators 460, and sensor subsystem 1093, including sensors 470. Actuators 460 may include solenoid operators or motor controllers for isolation or diversion valves, switches for operating heaters, mixers, aerators, conveyors, augers, screens and strainers, and other components. The sensors 470 may include sensors for monitoring RPM and vibration of rotating machinery, fluid temperature, pH, clarity, TSS, and other fluid characteristics of relevance to operation of the system 100. The system 1090 may include components for remote, automated sampling of waste streams. Such sampling components may include inline pH meters, turbidity monitors, and other sampling components. FIG. 12A shows centrifugal decanter 320 coupled to sensors 470i with control devices operated by actuators 460i.

FIG. 12B illustrates mechanisms to control operation of a typical component of the system 100. In FIG. 12B, centrifugal pump 461 is shown in communication with local processing unit 880 through which the centrifugal pump 461 may be started, stopped, and run at different speeds (for a variable speed pump—pump speed may be varied depending on the composition of the liquid being pumped, for example). The local processing unit 880 may receive sensor outputs from speed sensor 470A, vibration data from vibration monitor 470B, as well as from other sensors (not shown) that may sense pump motor voltage, pump temperature, and other parameters. In an aspect, centrifugal pump 461 may be automatically operated (i.e., without specific direction from a human user) with automatic shutdown upon detection of certain parameter values (e.g., vibration exceeding a limit, where the vibration may be caused by cavitation or pump damage, for example. An LLM-based local control program executing on the local processing unit 880 may prevent pump start if the pump's outlet valve (not shown) is not closed. This interlock, and other interlocks may be programmed into the local processing unit 880. Thus, the local processing unit may receive real-time data from other components (e.g., outlet valve position) whose operation could affect operation of the centrifugal pump 461. Furthermore, the LLM-based local control program may receive sensed component data such as RPM and provide that data to an associated LLM, and in an example, the LLM-based local control program may receive a response from the LLM with specific instructions for slowing the rotational speed of the centrifugal pump. A basic structure of such two-way communications between the LLM-based local control program and the LLM is disclosed in more detail herein.

FIG. 12C illustrates an example local/remote control scheme for operating the centrifugal pump 461. In FIG. 12C, centrifugal pump 461 is connected, at its intake, to intake tank 200 through valve 463. Valve 463 may be a manually operated isolation valve, and other valves, including motor-operated valves, may be in series with valve 463. At its discharge, centrifugal pump 461 connects to manually-operated isolation valve 464, which may normally be open. Following valve 464 is motor-operated isolation valve 465, coupled to motor 465A, followed by motor-operated throttle valve 466 coupled to motor 466A. Other valve configurations are possible. However, a throttle valve likely would be required to control pump discharge. Centrifugal pump 461 is rotated by motor 462, which may be a variable speed motor, and which receives power from power source 467 through switches 468 and controller 469. In an aspect, processor 810 executes machine instructions to control operation of the motors 465A and 466A, and the pump 461. Alternately, or in addition, local processing unit 880, which is shown including display screen or graphical user interface (GUI) 848, by executing an LLM-based local control program, may control the operation of the valve motors 465A and 466A, and pump motor 462.

FIG. 12D is a conceptual illustration of a component sensor network deployed for sensing component operational data as well as sampling station data in the herein disclosed waste stream processing systems, and using the data to control operation of system components. In FIG. 12D, component sensor network 841, which is distributed in a waste stream processing system 840 includes distributed (i.e., local) sensors 470, with a sensor 470 monitoring operation of various system components, including centrifuge 303, decanter 301, skimmer tank 200, and pump 461. Other sensors would be associated with sampling stations (not shown in FIG. 12D). Each local sensor 470 is configured to sense specific information from the system components. For example, one sensor 470 is configured to sense rotational speed of pump 461. Each sensor 470 is in two-way communication with remote processor 810, and provides the processor 810 with sensed values. In an aspect, the periodicity of taking sensed values may range from continuous to a time interval appropriate for the component being monitored. For example, rotational speed may be sensed continuously while a parameter indicative of filter efficiency such as differential pressure across the filter may be sensed every minute. The processor 810 may supply a derivation (e.g., conversion from analog to digital, discretion, or quantization, etc.) of the sensed values to a control program stored in data store 830, and placed in processor memory prior to initiation of a waste stream processing operation. The control program may be a LLM-based control program, and thus may cooperate with an trained LLM stored in the data store 830. Alternately, or in addition, the sensors 470 may provide sensed values to a network 831 of corresponding local processor units 880i, with each local processor unit 880i executing an LLM-based component control program (not shown in FIG. 12D). The local processor units 880i may be in two-way communication with processor 810.

FIG. 12E is a conceptual illustration of an example implementation of local processing units in communication with individual (local) components of the waste stream processing system and further in communication with a compute platform 811 that includes (central, remote) processor 810. The (central) processor 810 receives inputs from local processor units 880A-880n, which in turn, are in communication with components 890A-890n, respectively. In the example of FIG. 12E, each local processor unit would have encoded into a non-transitory, computer-readable storage medium, (not shown) a local LLM-based component operation plan program (or local LLM-based agent), and each local processor unit 880i would execute the component operation plan program to sense operational parameters as well as biological and chemical parameters (as appropriate) relevant to the local component 890i associated with the local processor unit 880i. The compute platform 811 also includes a system model 811C, which is a model of the entire waste stream processing system, a graphical user interface, or GUI 811B, and a man-machine interface 811A. The man-machine interface 811A allows a human operator or system expert to communicated directly with components of the waste stream processing system through operation of the various LLM-based operation programs. The GUI 811B presents alerts, suggestions, and other data and information such as the graph 610 of FIG. 8, to an operator or expert. The system model 811C provides elements that correspond to each of the waste stream processing systems disclosed herein, including processing units, tanks, rotating equipment, valves, motors, heaters, strainers, sensors, sampling stations and devices, and other mechanisms and components, as well as their operational parameters and relationships to each other. The system control program and individual component control programs incorporate data related to each of these mechanisms and components. The model 811C may be developed from a system map; FIG. 12G presents an example process for generating the system model 811C using the system map.

The local (small) processor units 880i shown in FIG. 12E facilitate and improve data interoperability, timeliness, and transmission efficiency. The units 880i form a local processor unit network, and the network e provides a data exchange mechanism between components 890i and (central) processor 810 of compute platform 811, thereby simplifying waste stream processing system operation, expansion, and efficiency. The local processor unit network provides bi-directional data exchange between and among system components and devices, including components and devices that may use differing data formats and differing data transmission protocols. In an example, the bi-directional data exchange may include monitoring and controlling components of the waste stream processing system, including rotating machinery, sensors, sampling stations, heaters, and filters. The (central) processor 810 and the compute platform 811 include processing assets, data storage assets, and human and machine communications assets. The local processor units 880i and corresponding network minimize or eliminate compatibility issues by providing an innovative, interactive data format determination coupled with a well-defined, extensible and configurable schematic notation that decodes and translates input data streams. In an aspect, the local processor unit network provides configurable and efficient data exchange between heterogeneous systems, subsystems, components, and devices.

The local processor unit 880i may be used in many different network architectures and schemes. The local processor unit network may be implemented with different features, components, and capabilities. The local processor unit network components may be structured to support a client-server scheme, a peer-to-peer scheme, and/or a publish-subscribe scheme, or combinations of these and other schemes. The local processor unit network is described herein for a use case in which each of a number of components 890i are configured for communication using an identical scheme/grammar and an identical data transmission protocol. In FIG. 12E, the local processor unit network is shown implemented in multiple components 890i, with one component 890i represented by and in communication with a corresponding local processor unit 880i. The components 890i may employ different grammars and transmission schemes. The components 890i may include pumps, conveyors, centrifugal separators, and other machines. Each component 890i may be instrumented with sensors capable of providing local and remote readouts. Local readouts may be provided through a gauge or a similar device. Local and remote readouts may be facilitated by use of the local processor units 880i. The components 890i also may include remote control features that may be implemented through the local processor units 880. Although FIG. 12E shows the local processor units 880i in communication with corresponding components 890i, FIG. 12E is not meant to imply a specific physical relationship. In one aspect, the local processor units 880i and the corresponding components 890i may be co-located while in another aspect, the local processor units 880i and the corresponding components 890i may be widely separated. Finally, the local processor units 880i may be implemented as virtual machines resident on the compute platform 811. Thus, local processor unit network may be viewed conceptually as a cloud (e.g., network 831 of FIG. 12D) that interfaces with multiple components and local processor units.

In FIG. 12E, a local processing unit 880i may be in a form of a standalone computing platform that may have a footprint ranging from that of a standard credit card to that of a standard tablet device. In an aspect, the local processing unit 880i may be in the form of a portable processing platform that includes a single chip processor; a rechargeable battery power supply; a bi-directional communications interface configured to communicate with one or more components 890i, and/or the sensors and sampling stations used to monitor the components, and may be further configured to communicate with other local processor units as well as the (central) processor 810. Each local processor unit 880i may include a non-transitory computer-readable storge medium having encoded thereon machine instruction for monitoring, reporting on, and controlling one or more of the components 890i. In another example, a local processor unit 880i may be implemented as a system on a chip (SoC) configuration in which a processor and other components are installed on board that may be inserted into a component 890i or a controller for the component 890i. Regardless of its physical form, a local processor unit 880i may include the structure needed to decode data streams of uncertain format from a component 890i, process and analyze (as appropriate) the data, and use the data to control the component 890i.

FIG. 12F is a block diagram of an example local (or small) processing unit, which in an aspect, is a component of the herein disclosed waste stream processing systems. In FIG. 12F, local processor unit 880 includes a local processor 881, voltage regulator 883, system controller 885, signal processor or data converter 886, machine-machine interface (M-M I/O 846), graphical user interface (GUI) 846, and memory components 884. The memory components 884 include EBI 884B connection to RAM, SRAM 884C, Flash memory 884D, and memory controller 884A. Other memory devices may be used. The local processor unit 880 may include an internal power supply 882 whose output is controlled by the voltage regulator 883. In an aspect, the power supply 882 is one or more rechargeable batteries or one or more non-rechargeable batteries. Alternately, or in addition, local processor unit 880 receives power from an external supply. In an aspect, the local processor unit 880 may store limited data and instructions in non-transitory computer-readable data store 847, as shown. The local processor unit 880 devices are connected by bus 849. Of particular note, the local processor unit 880 structure shown in FIG. 12F employs SRAM 884C, which allows faster operations than would be possible with certain other memory types. Use of SRAM 884C is made possible by the distributed nature of the local processor unit 880 network shown, for example, in FIG. 12E. That is, each local processor unit 880 is subjected to a minimal processing load, which allows use of faster memory located closer to a central processor (processor 881) than would be possible with current computing architectures. Although FIG. 12F shows a specific internal hardware implementation of a local processor unit 880, other internal hardware implementations, as well as software implementations, may be possible.

In one example, the signal processor or data converter 886 shown in FIG. 12F may receive data from sensors, such as the sensors 470 shown in FIG. 12D, and may convert the received sensor data into a format that is compatible with processor 881. A sensor 470i may “sense” a condition of a monitored component 890i. For example, sensor 470i may sample parameter values for pressure (or differential pressure), current, rpm, or torque at a rotary component 890i such as pump 461 of FIG. 12B. The parameter values may be sensed continuously or periodically. The sensed parameters may be analog signals, such a rotation speed at x revolutions per minute. The data converter 886 may convert the sensed analog parameter value into a digital value. The data converter 886 then may provide the digital value, along with a digital time stamp and an identification (ID) of the sensor to the processor 881. For continuous analog values, the data converter 886 may sample the continuous analog signal to produce discrete values that then are digitized. To reduce processing load on the processor 881, the data converter 886 may quantize the discrete values.

FIG. 12G is a flowchart illustrating an example process for generating a waste stream processing system process map (i.e., a map of the processes that have occurred, or are expected to occur, in an existing waste stream processing system) and generating, verifying, and validating a corresponding waste stream processing model from which the herein disclosed control programs, including LLM-based control programs are derived and used. The process of FIG. 12G may involve use of generative artificial intelligence (generative AI) to produce the process map. One specific type of generative AI that may be used in the process of FIG. 12G is a large language model. However, other AI techniques may be more appropriate for an existing waste stream processing system that has accumulated historical operational data. In FIG. 12G, operation 850 begins, block 851, with waste stream processing system process observations and discussions, including processing requirements, government regulations, processing goals, historical data, and other inputs from practitioners from the waste stream processing field, including operators, maintenance personnel, supervisors, regulators, experts, and other personnel. The observations and discussions may consider best practices for food (meat) processing effluent, use of specific components, and use of appropriate sensors and sampling stations. Thus, block 851 involves data collection, including component specification, operational logs (if available), and sensor data (if available). The collected data then are organized into a structured format, ensuring data clarity, consistency, and correctness. In block 852, the discussions result in activities or requirements for the waste stream processing system, including all components and mechanisms, with a consequent component mapping and corresponding process mapping of a proxy for an intended waste stream processing system. In an aspect, an LLM may be used to generate the proxy. In block 853, the proxy is tested to determine if the process map reflects an actual, or an expected process of an existing or an intended waste stream processing system; that is, does the proxy conform to an actual operation of the waste stream processing system. If the proxy so conforms, the operation 850 moves to block 855. If the proxy is not conforming, the operation 850 moves to block 854 and the map (proxy) is modified, after which the operation 850 returns to block 851. In blocks 855-857, the operation 850, after recording activities durations (block 855) involves an optional statistical analysis of the process flow embodied in the map (i.e., the proxy). The statical analysis (block 856) may be used subsequently to provide (block 857) a confidence interval for the eventual model. In block 858, a model is constructed from the map (proxy). That is, the map is translated into computer-readable code or language (the model) that may be combined with specific tools for use as a control program for the waste stream processing system and/or for local control programs for waste stream processing components such as centrifuges and decanters. The model generated in block 858 then is verified and validated, and modified as needed, blocks 859, 861, and 862. Such model verification and validation may be tested using a simulator, or an actual system conforming to the map of blocks 851-854. In optional block 863, block 864, and block 865, the validated model may be streamlined to reduce processing load, and tested to determine if the streamlined model and the base model produce sufficiently similar and consistent results. Following block 865, operation 850 ends.

FIG. 13 is an example implementation of an LLM-based control program in the system 100 to control operation of specific system 100 components. In FIG. 13, and with reference to FIGS. 8 and 12A-12F, in an aspect, large language model (LLM) 620, which has been trained using the system 1000 and its components is linked to a control program, such as control program 832 of FIG. 8, that is used for semi-automatic or automatic, real-time control of the waste stream processing system 100. That is, control program 832 is an LLM-based control program. In an aspect, the LLM-based control program detects actual or potential events, formulates a query or prompt (see FIG. 10B) based on the events, and provides the query (in the form of, or along with, an engineered prompt as appropriate) to the LLM 620. The LLM 620 responds to the query or prompt with specific instructions or suggests as to how best to address the actual or potential events. For example, the control program may receive a differential pressure reading for the strainer 203 of FIG. 2C and provide that differential pressure reading to the LLM 620 in the form of a query or prompt such as “the differential pressure of strainer is at the maximum set point what action should be taken? In another aspect, LLM 620 is seen, conceptually, to access a block header 622 of the distributed ledger 867 of FIG. 8. LLM 620 also may access alert module 628, which may be implemented through an algorithm 624 (e.g., a smart contract) such that when certain event data 626 stored as a result of the sensor 470 readout operation dictates, the algorithm 624 may be executed by processor 810 to provide visual and/or audible indications of a potential problem with, or otherwise, a current status of, the waste stream processing system operation. Either of the two above aspects of LLM implementation may provide automatic or semi-automatic, real time operational control of system 100 components, such as motors, heaters, and valves. In FIG. 13, event data such as sensor readouts for pH, temperature, oxygen content, viscosity, and/or any parameter indicative of the operation of the system 100 and progress, or percentage completion of the operation may cause a code snippet or algorithm 624, or the control program 832, to be executed by the processor 810. In one scenario, event data are compared to expected values as an indication of the rate of reaction/reaction progress toward completion of the overall waste stream processing operation, or some segment of the overall operation. In FIG. 13, this comparison is provided for illustration purposes as graph 610 with computed progress curve 612 and expected value curve 614. The graph 610 may be displayed visually to operational personnel monitoring waste stream processing operations. The LLM 620 also may cause retention of the data from which actual, or computed curve 612 is formed. If the comparison indicates a sufficient divergence between the computed curve 612 and the expected value curve 614, the algorithm 624 may execute to provide an alert, which may be displayed to operational personnel. Such comparison also may cause the control program 832 to query the LLM 620, whereby the control program 832 “asks” the LLM 620 for potential corrective action, and the LLM 620 responds with a most relevant corrective action (e.g., slow down effluent flow in the waste stream processing system). For example, based on the progress curve shown in 610, the control program 832 provides the following system-wide query (as opposed to a query specific to a specific component): “It is now 1050. At time 1105 the computed progress is expected to begin decreasing and at time 1135, will fall below the desired progress. What action do you recommend?” The LLM responds with {“action”: “stop_decanter”, “value”: “at_1105”}.

In a further example operation of an LLM-based control program, the control program 832 provides the following system-wide query: “The current system state is heater at 80 C, TDS at 420 mg/L, centrifuges in serial operation at high speed. What corrective action do you recommend?” The LLM 620 responds with {“action”: “reduce_flow_rate”, “value”: “10%”, “target”: “all_centrifuges”}. In response, the control program slows the serially-operated centrifuges by ten percent. In yet another example, the control program 832 provides “The vertical decanter sludge rate has increased by 30% over the last hour. Centrifuge vibration levels are rising. Effluent TSS is above target. What action do you recommend?” LLM 620 provides the following response: {“action”: “reduce_feed_rate”, “value”: “15%”, “target”: “decanter_1”; “check_differential_pressure”, “target”: “strainer”}. The control program 832 then translates the LLM 620 response into a local process unit command.

In addition to the above responses, the conditions, queries, prompts, and responses noted above may be stored in a block referenced by header 622, and may be used to notify operational personnel as to the condition of the system 100. The algorithm 624 also may signal and store data in the immutable distributed ledger 867 when the waste stream processing operation reaches a defined endpoint. The stored data of operation completion may include a unique batch identifier or serial number. The unique batch identifier or serial number may be used as part of the organization's environmental records, and may be associated with any reuse products generated using saved materials (i.e., solids) from the waste stream processing operation. Either automatically as part of algorithm 624 or another algorithm, or manually under control of operational personnel, a potential block of the immutable ledger 867 may be validated, multicast to selected entities, and added to the immutable ledger 867, eventually making the added block immutable.

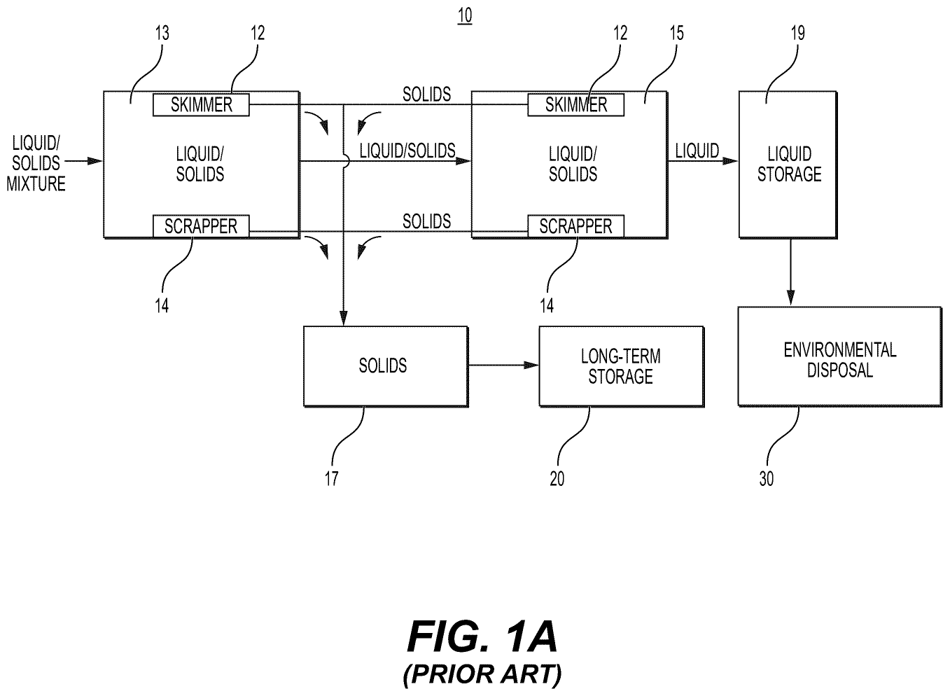

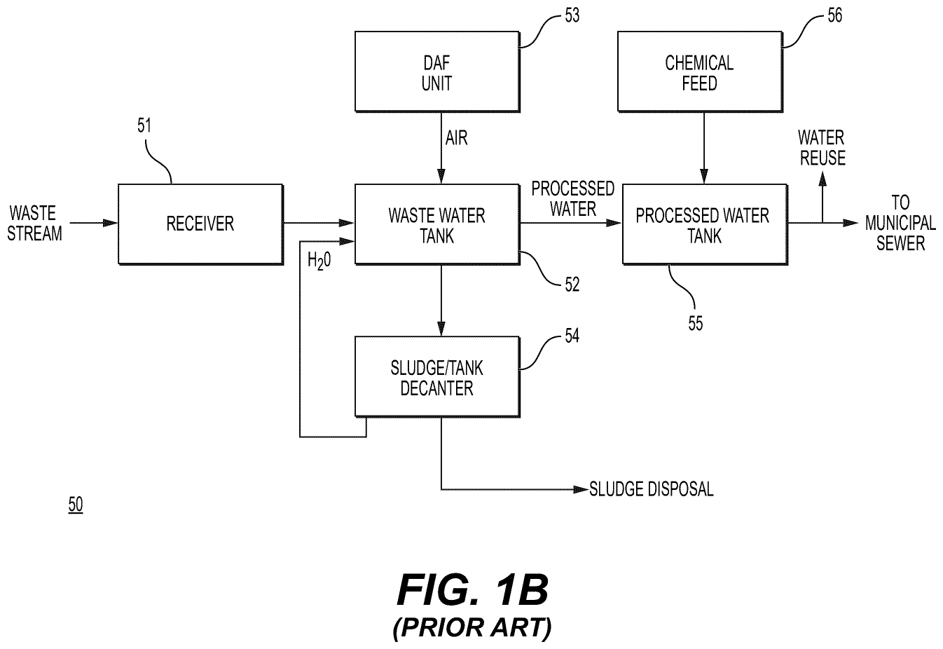

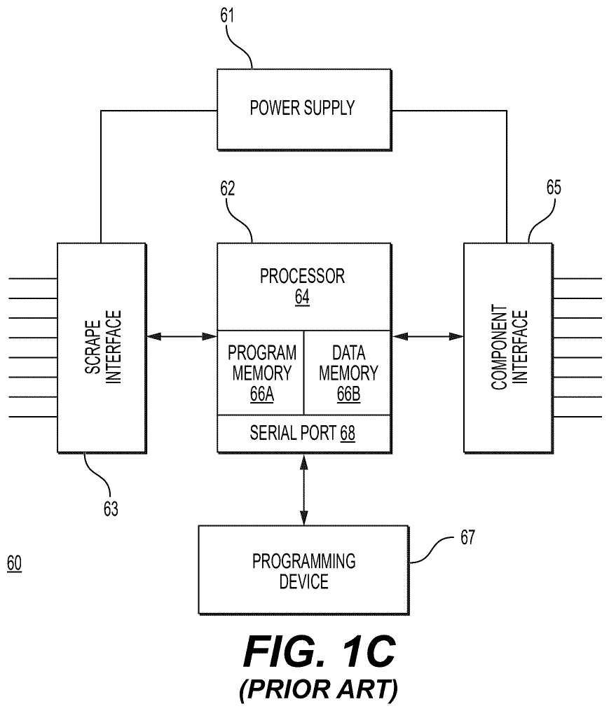

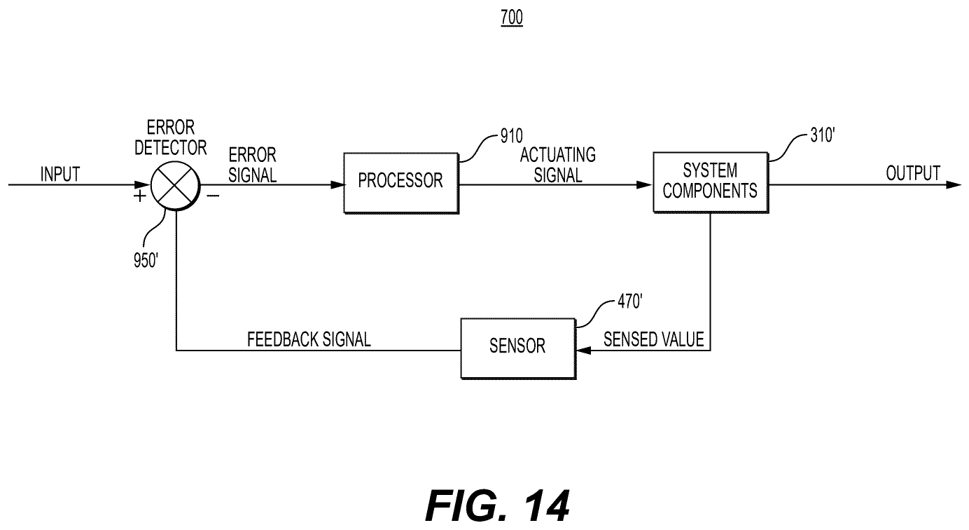

Rather than control by implementation of an LLM-based intelligent agent, the system 100 may be controlled by the processor 910 executing a closed loop feedback mechanism. FIG. 14 illustrates application of an example feedback and control loop to control operation of the herein disclosed waste stream processing system 100. In an aspect, the system 100 could be operated as a single degree of freedom system where only TSS or rpm, for example, are to be sensed and to be controlled. With reference to FIGS. 1, 9, and 12, in FIG. 14, feedback control loop 700 includes system components 310′, such as decanter 320, which is instrumented with sensor 470′, which in turn provides a feedback signal to error detector 950′, which is a component of program 950. The error detector 950′ is executed by processor 910, which generates an actuator signal to control one or more components 310′, such as a water doser to provide, for example, clean water to the decanter 320. In an aspect, the sensor 470′ is an rpm sensor, and the processor 910 controls decanter motor speed, and hence, decanter 320 operation through analysis of the sensed rpm value, alone.

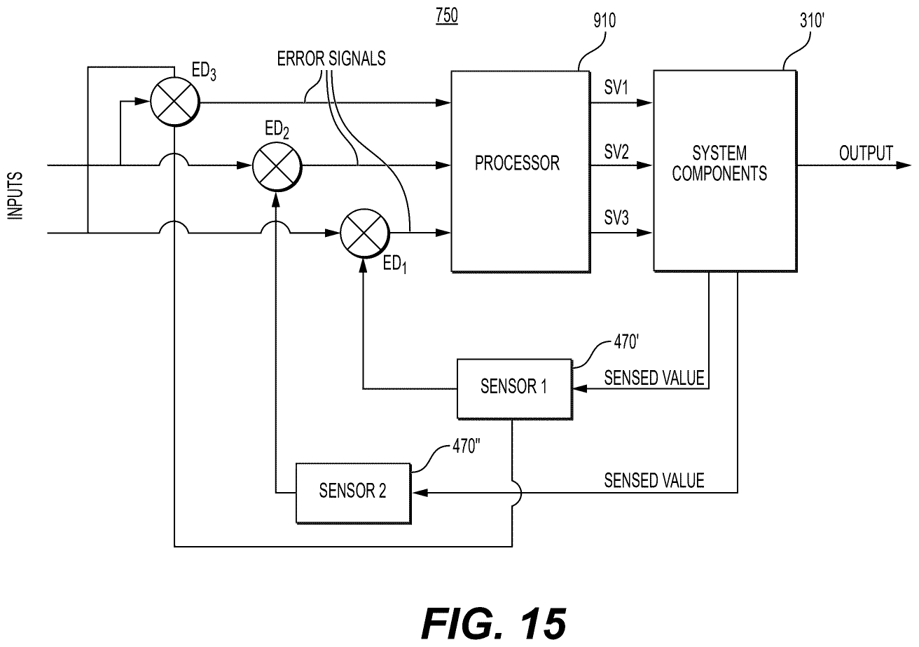

FIG. 15 illustrates application of another example feedback and control loop to control a two or more degree of freedom system, such as the system 100. For example, the system 100 may be said to be at least a two degree of freedom system when both rpm and TSS concentration are independently sensed/controlled. Moreover, a ratio of the two measurable parameters may be used for control. In FIG. 15, with reference to FIGS. 1, 9, and 12A-12F, closed loop feedback system 750 includes system components 310′ (e.g., decanter 320) instrumented with a first sensor 470′ and a second sensor 470″. Each sensor sends a feedback signal to an associated error detector EDI1, EDI2, respectively'. The two sensors 470′ and 470″ also send the feedback signal to error detector EDI3. Error detector EDI3 differs in operation from error detectors EDI1 and EDI2 in that error detector EDI3 combines the sensed values to generate a ratio of the two sensed values, and compares the generated ratio to a desired or expected ratio to generate an error signal. The processor 910 uses the error signal to generate actuating signals SV1, SV2, and, optionally SV3, to operate components of system 100.

As disclosed above, the waste stream processing system may be configured to operate under control of a central processor, a central processor combined with a network of local processing units, or by using a feedback and control loop architecture. The waste stream processing system also may be operated in a purely manual mode, using, for example, gauges, manual control of valves, manual-electric control of valves, and manual control of pumps, for example. Thus, in the manual mode, rotating machinery may be started and stopped by an operator, and machinery speed may be rheostat-controlled. The waste water processing system may be controlled in a semi-automatic mode or in a fully-automatic mode. In either semi-automatic operation or fully automatic operation, the waste stream processing system may employ an LLM-based control program. When using local processing units, each local processing unit may include a local LLM-based control program. Other combinations of generative AI-based control programs may be employed.

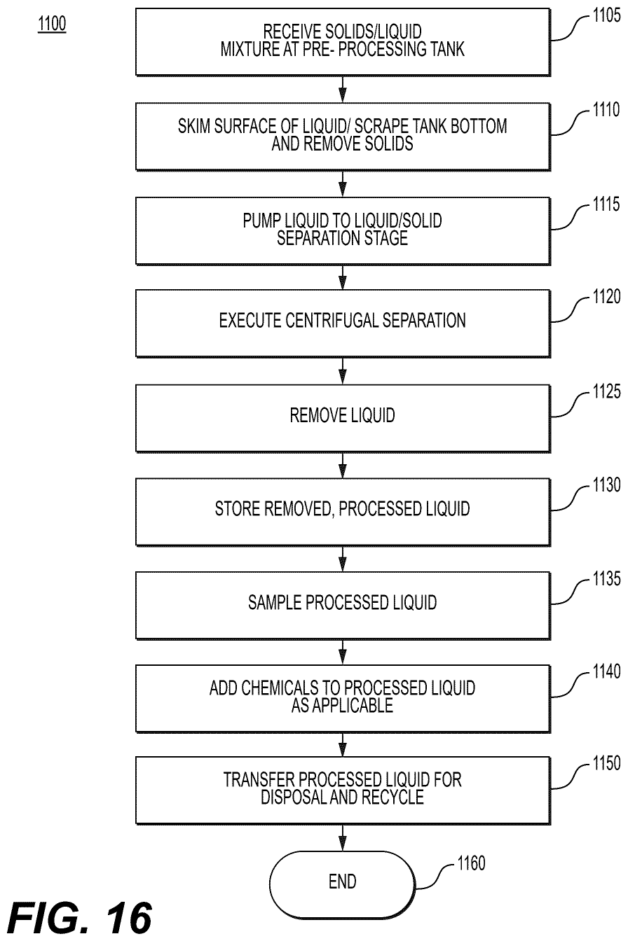

FIGS. 16-20 are flow charts illustrating certain operations of the system 100 of FIG. 2A, and its various components as shown in and described with respect to FIGS. 2B-15. Moreover, the operations will be described considering processing of a waste stream resulting from product of poultry-based food products.

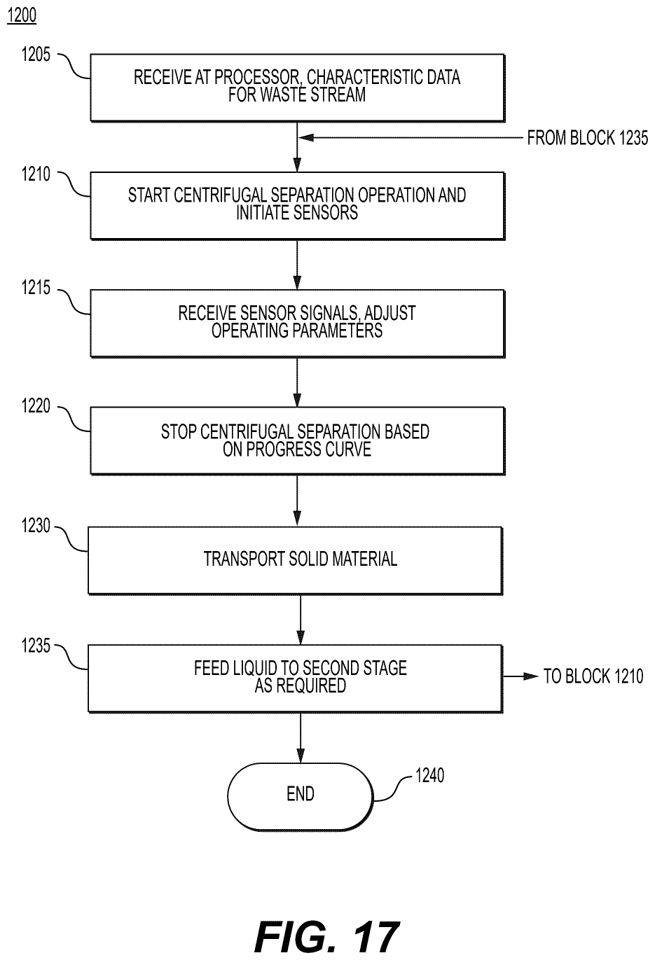

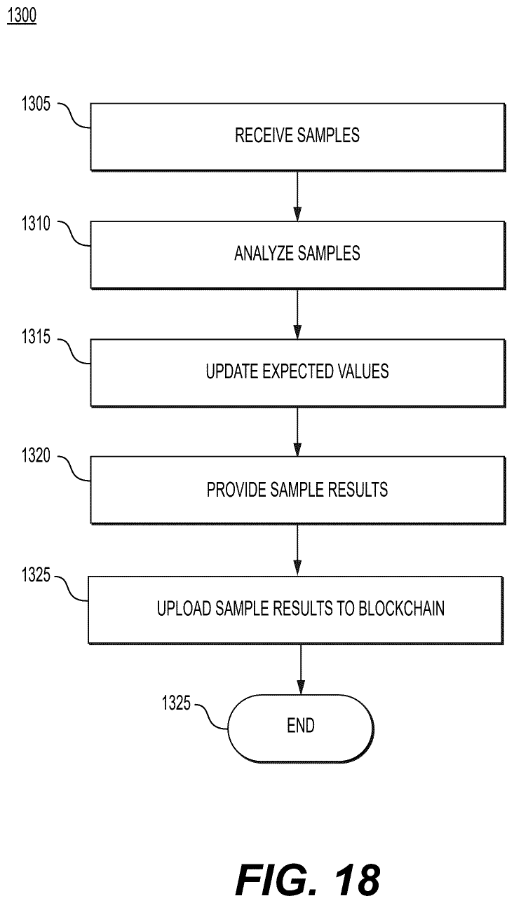

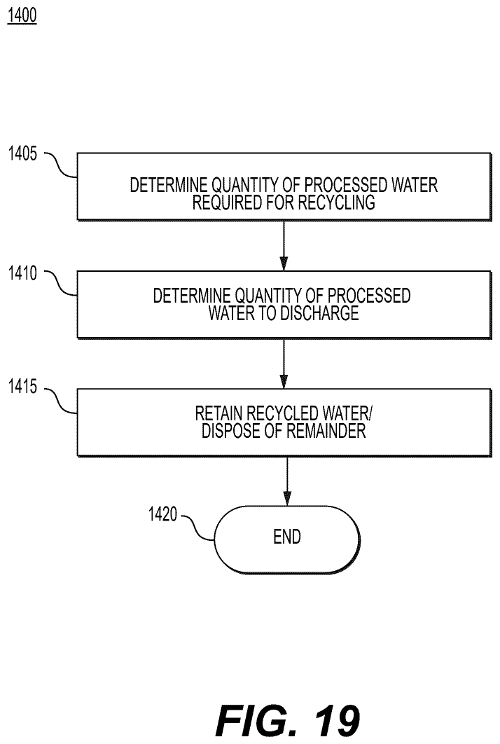

FIG. 16 is a flow chart illustrating an example operation of the system 100 of FIG. 2A. In FIG. 16, operation 1100 begins at block 1105 with the system 100 receiving at pre-processing intake tank 200 a solid/liquid mixture waste stream from the production of poultry-based food products. At block 1110, processor 810 signals components of the intake tank 200 to begin operations to skim the liquid surface and to scrape the tank bottom to collect any solid matter that may have floated to the surface or sunk to the bottom. The operation of block 1110 may begin as soon as tank filling is sufficiently complete such that skimmer 12 can begin operation, with the objective of removing solids that are not useable for generating recyclable products. For example, the solids removed by the operation of block 1110 may be primarily bones and feathers. The processor 810 may continue the pre-processing operation of block 1110 until a preset time (i.e., the LLM 620 may be executed based on learned, historical data for this operation), until an operator signals to stop the operation, or until a sensor indicates no more, or a sufficiently low volume of solids are entering the solids storage tank 120. Note that in this operation of block 1110, the removed solids may be directed, through operation of a simple gate valve (not shown) to a first compartment of the solids storage tank 120. Following block 1110, operation 1100 moves to block 1115, and the processor 810 activates a pump or other transfer mechanism, to commence movement of contents of intake tank 200 to liquid/solids separation stage 300. In block 1120, the processor 810 controls stages of centrifugal separation machinery to execute centrifugal separation of solids (sludge) from the liquid/solid mixture. The operation of block 1120 is shown in more detail in FIG. 17. During and following centrifugal separation, operation 1100 moves to block 1125, and the processor 810 controls a pump (not shown) or other transfer mechanism, to move processed liquid from the liquid/solids separation stage machinery. That is, liquid removal occurs continually or episodically as the operation of block 1120 executes. Following the transfer operation of block 1125, the processed liquid is stored in a liquids holding tank, block 1130. The process of block 1130 also may occur episodically. The episodic operations of blocks 1120, 1125, and 1130 allow use of smaller components for downstream processing of a large volume from pre-processing intake tank 200. In block 1135, the stored, processed liquid is sampled. Liquid sampling of block 1130 is shown in detail with respect to FIG. 18. Should the liquids sampling of block 1135 indicate a need to adjust the chemical makeup (e.g., increase or decrease pH) of the stored, processed liquid, the operation 1100 moves to block 1140, and appropriate chemicals are added to the liquids holding tank. If/when the samples show satisfactory results, the operation 1100 moves to block 1150 and the processor 810 controls a first transfer mechanism to transfer the processed liquid for disposal, and, optionally, controls a second transfer mechanism to transfer a portion of the processed liquid for recycling in either or both the poultry meat production facility and the waste stream disposal system 100. The operations of block 1150 are shown in more detail with respect to FIG. 19. Following block 1150, operation 1100 ends at block 1160.

FIG. 17 is a flowchart illustrating operation 1200, centrifugal liquid/solid separation of the pre-processed waste stream. In FIG. 17, operation 1200 begins in block 1205 when the processor 810 receives characteristic data for the waste stream that is to be further processed using centrifugal separation. The characteristic information may include data indicative of the viscosity of the waste stream, and the processor 810 may execute LLM-base control program 832 to adjust initial operations of the centrifuge components based on the viscosity readings. Viscosity may be measured directly, or may be inferred using other data such as TSS, clarity, pH. Viscosity may be further inferred based on the source of the waste stream, for example, from poultry processing, and within poultry, whether chicken, turkey, or another form of poultry. The LLM 620 may be executed to make this inference. Viscosity may be an important parameter to use in the initial operation because more viscous fluids may require slower speed operation, and because more viscous fluids may be closer to a desired endpoint, namely, de-watering as much as possible. Viscosity and other parameters may affect an operational configuration of the centrifuge components; for example, the processor may operate two centrifugal decanters in parallel or in series depending on the viscosity and other parameters, and historical information related to processing such fluid waste streams, with the historical information used to train the LLM 620. With an initial configuration of the centrifugal components decided, and initial speeds determined, the operation 1200 moves to block 1210 and the appropriate centrifuge components are supplied with the waste stream, and are started. In block 1215, sensors provided with the operating centrifugal components provide data to the processor 810, which, executing the LLM- based control program 832, adjusts the operating parameters and component configurations until an expected value (see FIG. 13) is approached or achieved. The processor 810 may stop, block 1220, this first substage of centrifugal separation when the curve (see FIG. 13) flattens such that little additional progress would be achieved by continued operation. During operation 1200, a fluid waste stream may be continually supplied and both solid material (e.g., sludge) and processed water are continuously removed. The solid material is transferred, block 1230, to tank 120 (and may be stored in a separate compartment of tank 120 so as not to mix with solid effluent from pre-processing stage using intake tank 200. The liquid is fed, block 1235, to a second substage of centrifugal separation, if required. When no further influent is to be separated, operation 1200 then moves to block 1240 and ends.

FIG. 18 is a flowchart illustrating waste stream sampling operation 1300. Such sampling may be implemented in part by the components of system 1090 of FIG. 12A, in cooperation with processor 810 and LLM-based control program 832 of FIG. 8 and the large scale model (LLM) 620 of FIG. 13. In FIG. 18, operation 1300 begins in block 1305 when samples of the waste stream are obtained and, in block 1310, when the samples are analyzed. For example, the system 100 may be configured to automatically obtain and analyze turbidity samples of processed water; the turbidity sample may be analyzed by comparison to known visual (machine readable) standards. Moreover, the LLM 620 may learn what the actual turbidity values for a current waste stream are, and may update, block 1315, the visual standards appropriately. Other samples may provide pH, Cl⁻ concentration, bacterial counts, etc. The operation 1300 may continue, block 1320, with a hard copy or electronic copy of the sample results made available to operational personnel. In block 1325, the processor 810 may upload the sample results for ultimate storage in a block of the distributed ledger, where the sample results will become immutable.

FIG. 19 is a flowchart illustrating transfer operation 1400 for transferring processed water for disposal and/or recycling. In FIG. 19, operation 1400 begins with the processor 810 of FIG. 8 executing the LLM 620 to determine (block 1405) how much processed water is needed for recycling purposes (the supposition being that the processed water is acceptable for environmental disposal). For example, after each “operational shift” of the attached poultry processing facility, workers are required to thoroughly clean the facility. If the processed water is suitable for such cleaning, some quantity may be recycled back to the facility. The remaining water may be disposed of in the environment with some further portion reserved for operation of the system 100. In block 1410, the processor 810 executes LLM-based control program 832 to direct operation of system 100 to discharge the determined quantity of water to the environment, and in block 1415 direct operation of the system 100 to retain portions of the water for (1) facility cleaning, and (2) operation of the waste stream processing system 100. Operation 1400 then ends.

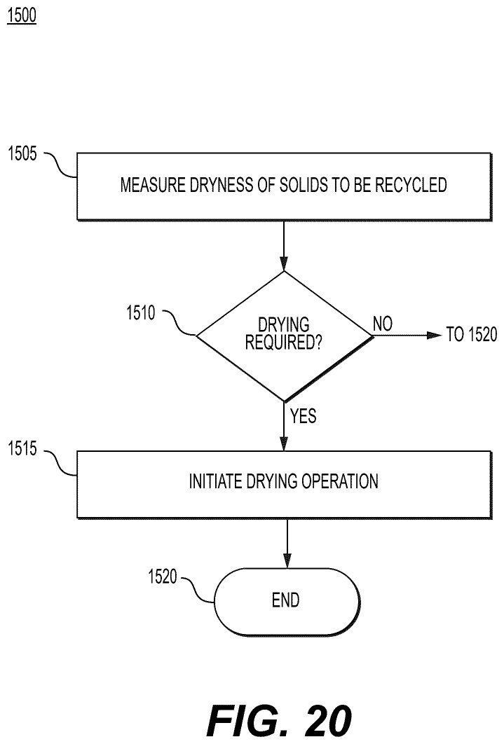

FIG. 20 is a flowchart illustrating optional solid drying operation 1500 for pre-drying solid sludge held in storage prior to recycling or disposal. Components of the system may achieve some drying of the sludge (solids) discharged to solids retention tank 120. However, prior to recycling these stored solids, additional drying may be effectuated through invoking operation 1500. In operation 1500, block 1505, the processor 810 executed LLM-based control program 832 to determine a “dryness” value for the stored solids that may be recycled. Such a dryness determination may be measured manually by operational personnel, automatically by sensors located in tank 120, estimated by execution of LLM 620 using historical values, or by using data from other sensors activated during the waste stream processing. In block 1510, if additional drying is indicated (e.g., as a suggestion from LLM 620 to the LLM-based control program 832), operation 1500 moves to block 1510 and the processor 810, executing the control program 832, invokes one or more drying routines. In an aspect, the system 100 may be controlled to supply hot, dry air to the tank 120. Other drying operations are possible. The duration of the drying operation of block 1510 may be based on external time constraints such as time to produce the recycled products, and time until next used of the tank 120 for solids storage. Following block 1510 during operation, operation 1500 ends.

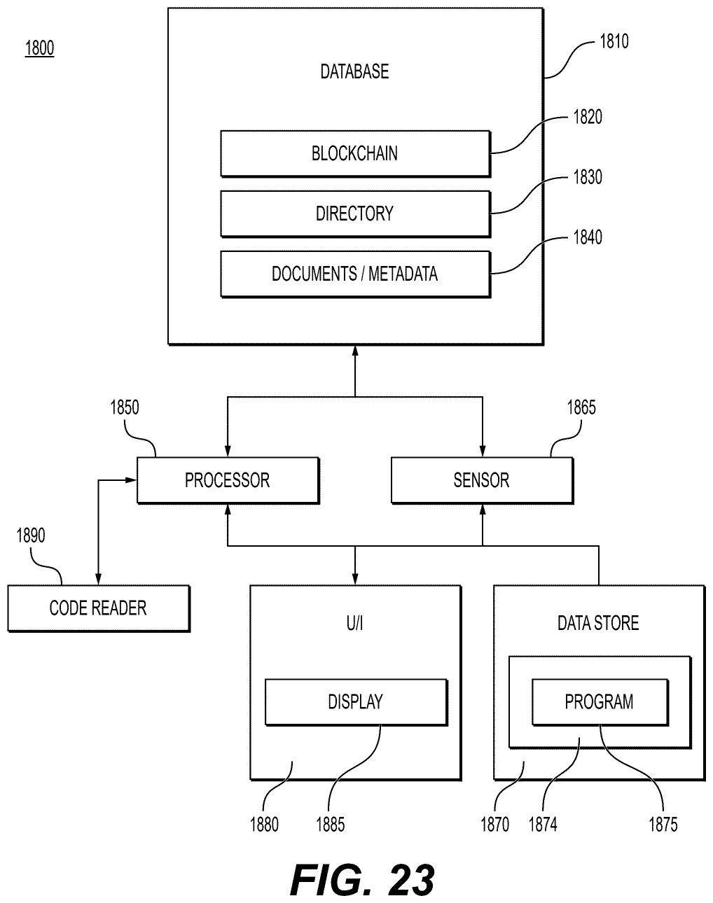

FIG. 21 illustrates example system 1600, which may be used to reprocess or recycle certain waste materials from operation of the system 100, and to provide those reprocessed waste materials as, or for inclusion in, environmentally-acceptable products. Thus, system 1600 operates to significantly reduce the harmful effects of waste stream processing operations of system 100. In FIG. 21, reuse system 1600, under control of processor 810 (coupled to processor platform 1610), or under control of a separate processor (i.e., in processor platform 1610), includes solids storage tank 120. Solids storage tank 120 may be configured with two compartments, or as two separate tanks. A first compartment includes solids removed in a pre-processing stage using intake tank 200. A second compartment stores sludge removed during the centrifugal separation processes of FIGS. 16 and 17. Tank 120 includes in a sensor suite, a sensor 470 that senses an amount of sludge retained, dryness of the sludge, and other characteristics, including, for example, pH. The sensor 470 is coupled to processor platform 1610. Coupled to an outlet of tank 120 is a transfer mechanism (not shown) to move the sludge to dryer 1620. The transfer mechanism may be an auger or similar device, or an auger in combination with a conveyor. The dryer 1620 receives a drying gas (air), possibly pressurized, to dry the sludge. The dryer 1620 may include an internal mixer (not shown) to speed the drying process. The dryer 1620 includes a combined actuator/sensor suite 460/470, which is coupled to processor platform 1610. The sensors sense dryness and amount of drying sludge, and the actuators 460 operate under control of processor 810 to apply drying air to the sludge and operate the internal mixer of the dryer 1620. The dryer 1620 operates at a rate that will empty the second compartment of the tank 120 in a time frame that will allow further operation of the waste stream processing system 100 (that is, process another batch of poultry waste). The system 1600 further includes a pelletizer 1640, or other processing machinery, that receives the dried sludge and forms the dried sludge into pellets or other suitable shape for transfer to a manufacturer for production of a finished product such as an organic fertilizer. In an aspect, the organic fertilizer may be finished using components (not shown) of system 1600, and the finished organic fertilizer may be packaged and provided to fertilizer distributors. The sludge may be transferred from the dryer 1620 to the pelletizer 1640 using any suitable transfer mechanism (not shown) such as, for example, a conveyor. The pelletizer 1640 includes actuator/sensor suite 460/470 to sense characteristics of the dried sludge as it is pelletized. The sensors 470 may provide sensed values to processor 810, which, executing the LLM-based control program 832, may direct supply of certain additives from additives tank 1630 to the pelletizer 1640. Alternately, the certain additives may be supplied at the dryer stage. The additives tank 1630 includes actuator/sensor suite 460/470 to control supply of the additives. The system 1600 thus generates pellets 1650 as precursor elements of an organic fertilizer, or alternately produces the finished organic fertilizer. Associated with a specific batch of pellets 1650 may be a code (not shown) that is stored by way of a distributed ledger (e.g., a blockchain), an example of which is shown in FIG. 23.

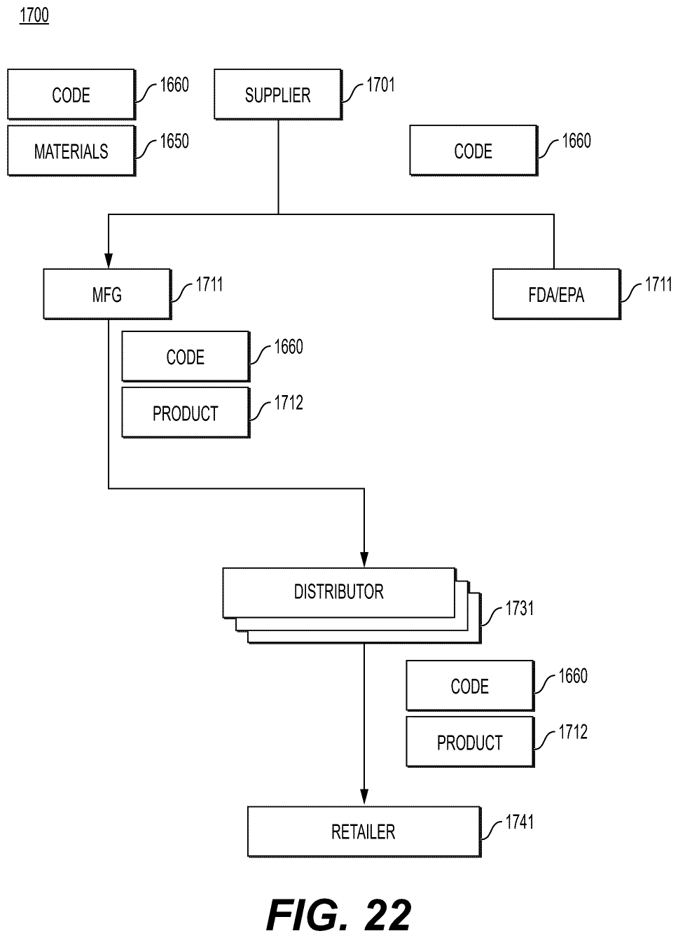

FIG. 22 illustrates an example manufacturing and supply chain for secure and verifiable distribution of the pellets 1650 to a fertilizer manufacturer and ultimately to retailers such as big box stores. In FIG. 22, supply chain 1700 includes raw materials supplier 1701, which may be the operator of system 100 and corresponding system 1600 (i.e., the pellet producer). Supplier 1701, in addition to supplying the raw materials (pellets 1650) provides a code 1660 (e.g., a batch code) to accompany the raw materials as the raw materials move through the supply chain 1700. The code 1660 may be affixed to packaging for the raw materials. The code may be a bar code, a QR code, a near field communication (NFC) code or other RFID code, or any other suitable, machine-readable code, whether radiofrequency, magnetic, electronic, or optical. The supplier 1701 provides the pellets 1650 and the code 1660 to manufacturer 1711, which then manufacturers finished fertilizer product 1712, and attaches code 1660 thereto (and may affix other coders as well). Supplier 1701 may, optionally, provide the code 1660 to a government agency or regulatory body 1707 such as the Federal Environmental Protection Agency and the Food and Drug Administration. The manufacturer 1711 provides the product 1712 and the corresponding code 1660 to one or more distributors 1731, which in turn, supply the product 1712 and the code to retailer 1741. The code 1660 may be accessible by any of the entities shown in FIG. 22, before or after material/product shipment though use of a distributed, immutable ledger accessible to each of the entities.

FIG. 23 illustrates an immutable, distributed ledger system 1800 for use by entities of the supply chain 1700 of FIG. 22. Each of the entities shown in FIG. 22 may have permissioned access to a distributed ledger/blockchain that is stored and maintained in related databases at each of the entities. The distributed ledger system 1800 includes database 1810, which in turn includes blockchain 1820 as an example distributed ledger, directory 1830, and documents/metadata 1840. Coupled to the database 1810 are processor 1850 and sensor 1865. Also included in system 1800 are data store 1870 with program 1875 stored in a non-transitory, computer-readable storage medium 1874. In one example, each entity of FIG. 22 may generate data (events) and enter that data (events) into blocks that are multicast to the other entities and incorporated into the blockchain 1820. In another example, certain proprietary events/data may be entered on a limited access basis, or not entered at all. As part of the block construction and distribution process, the blocks are validated using a block validation routine or algorithm. Thus, and in an example implementation, each entity maintains a local (distributed) and validated copy of the entire blockchain 1820. In still another example implementation, only selected entities maintain the blockchain 1820 in its entirety, and other entities may generate block that are contributed to the blockchain 1820 without retaining the entire blockchain 1820. For example, the distributors 1731 and manufacturer 1711 may not wish to share proprietary information with other entities, and thus, some blocks may have access limitations, and some entities, such as FDA/EPA 1721, may not have any access to the blockchain 1820. In another aspect, some entities only have access (or limited access—i.e., to a limited set of blocks) to the blockchain 1820 and do not contribute blocks to the blockchain 1820, akin to a read-only feature. The machine-readable device (code 1660) may be printed on or affixed to discrete units or packages containing the finished product 1712. The machine-readable device may be further modified to indicate lot numbers, individual product container numbers, or any other unit or package used for the distribution of the pharmaceutical product. For example, a distributor 1731 may package pallets of the product 1712 for delivery to a retailer 1741, and may append code as a component of a label affixed to the pallet. Scanning the code 1660 may provide access to the blockchain 1820, an associated blockchain directory 1830, and digitized copies of documents/metadata 1840 related to the production and distribution of the product 1712. The system 1800 further includes processor 1850, which may be coupled to user interface (U/I) 1880 having display 1885 and data store (non-transient computer-readable storage medium) 1870, which includes, as machine instructions, program 1875. Code reader 1890 may be implemented (e.g., as an application) on a portable device such as a smart phone, a dedicated code reader, or as a component of fixed structure or machine. Some entities of FIG. 22 may include one or more sensors 1865 that sense signals/information related to the products 1712 during their movement through the supply chain 1700. In an aspect, one or more sensors 1865 may be included within or as an element of packaging that contains the products 1712 during their travels through and storage in all of or in portions of the supply chain 1700. In one implementation of the system 1800, an individual or automated machinery at one of the entities, such as the retailer having its own storewide distribution network, uses code reader 1890 to read a code (e.g., an RFID code, a QR code, or other machine readable code) affixed to a product 1712 and/or the product's packaging. The read code is transmitted to the processor 1850. The processor 1850 uses the read code to identify the blockchain directory 1830, which action provides a link to blockchain 1820 and to documents/metadata 1840 associated with the product 1712. The individual then can verify the provenance of the product 1712 and verify the product 1712 has indeed originated as raw materials 1650 provided by supplier 1701, which moved to manufacturer 1711 where the raw materials were formed into the product 1712. The product 1712 then traveled to distributor 1731, remained in storage at distributor 1731 for a specific time, and then was shipped directly to retailer 1741. If the packaging for product 1712 includes sensor 1865, the individual may review sensor data logs (e.g., product temperature) for the duration of the product's time in the supply chain. The individual also can access documents 1840/metadata, such as shipping manifests, that are digitized and stored in database 1810 and referenced back to a specific block in blockchain 1820. When automated machinery is used for code reading, the product packaging may be scanned as the product 1712 traverses the automated machinery (e.g., by conveyor belt), and the read code may link to a specific blockchain 1820 and within that blockchain 1820, a specific block or blocks. In this manner, an entity receiving a product 1712 may verify its provenance, update (add a block to) the blockchain 1820, and multicast the block to other entities of FIG. 22. Similarly, sending entities may confirm the proper delivery of the product 1712 by viewing the updated blockchain 1820. Any deviations from normal or expected information could indicate a problem.

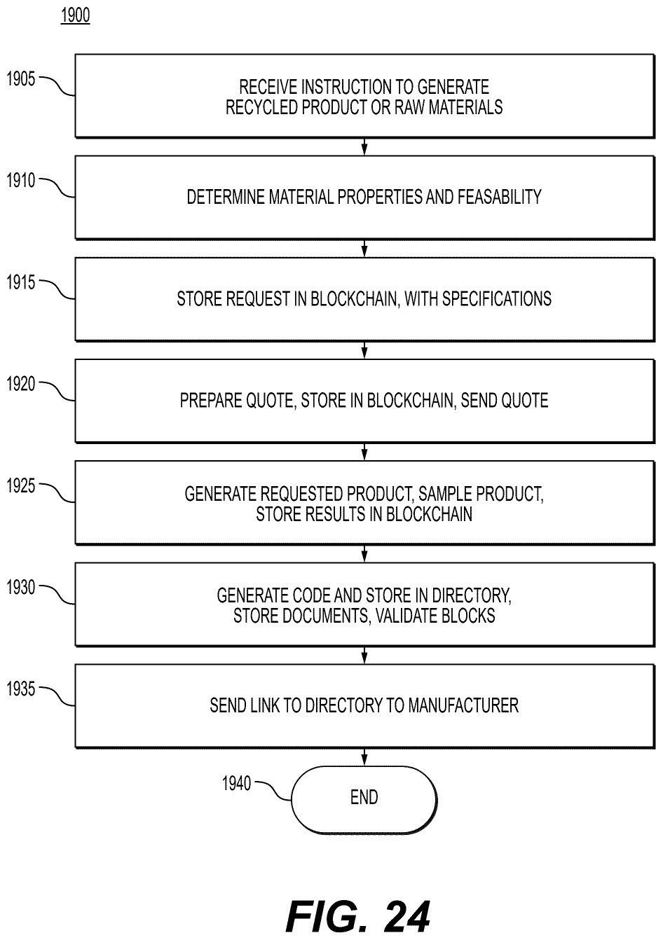

FIG. 24 is a flowchart illustrating a recycling operation of the system 1600 of FIG. 21. In FIG. 24, recycling operation 1900 begins in block 1905 when processor 810 (or a processor of processor platform 1610) receives an instruction to generate a recycled product, or to generate raw materials from which a recycled product may be manufactured. In an aspect, certain manufacturers may provide raw materials specifications, finished product specifications, or semi-finished product specifications to the operator of system 100 (or the larger food processing facility). The processor 810 executes, block 1910, the LLM 620 to read (using NLP engine 1028 if necessary) the specification and to determine if the materials generated by operation of the system 100 may be processed to meet those specifications. The processor 810 executes the LLM 620 to determine how much (what quantity) of waste products (dried sludge, for example) will be required for processing to meet the manufacturer's requirements, as well as the time required to deliver. For example, a manufacturer may require a raw material in granular form or a semi-finished product in pelletized form. The processor 810 stores, block 1915, the quoted request in a block of blockchain 1820 and in block 1920, prepares a quote for approval by facility management. The quote also is stored in the blockchain 1820. Once the quote is accepted, the processor 810, using the LLM, in block 1920, controls operation of solids reuse system 1600 to generate the requested product or material. The processor 810, during the recycling operation, obtains product and material samples, directs analysis of the samples, and stores the sample and results in the blockchain 1820. When the recycling operation is complete, the processor may, block 1925, generate a random code and a corresponding identifier, place the code and identifier in the directory1830, store documents/metadata 1840 in database 1810, and validate the block containing the quotes, materials requirements, and sample results. In block 1930, the processor send a link to the directory 1830, allowing the manufacturer to access the now immutable data and corresponding documentation. The operation 1900 then ends.

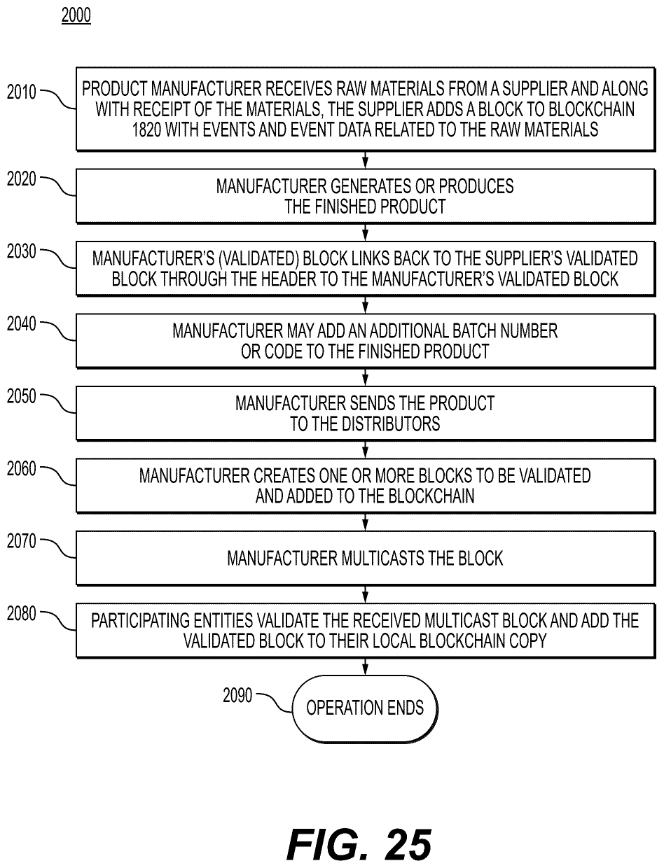

FIG. 25 is a flowchart illustrating an example operation, executed by a product manufacturer 1711 of FIG. 22 using the system 1800 of FIG. 23 to generate a blockchain, or to add blocks to an existing blockchain, such as blockchain 1820, for a fertilizer product 1712 produced from raw materials provided by a supplier 1701 for distribution to one or more distributors 1731. In an aspect, the manufacturer 1711 may add other materials to the raw materials. In FIG. 25, operation 2000 begins in block 2010 when a product manufacturer 1711 receives raw materials from a supplier 1701. Along with receipt of the materials, the supplier 1701 may have added a block or blocks to blockchain 1820 with events and event data related to the raw materials such as their provenance, composition, source, quantity, environmental storage requirements, and other data. Once the supplier's block(s) is validated, that block may be added to the blockchain 1820, giving the manufacturer 1711 access to the events and event data contained within the supplier's validated block(s), as well as access to any documents/metadata 1840 associated with the raw materials. A hash header for the supplier's validated block may be stored in the blockchain directory 1830, As part of the raw materials supply, the supplier 1701 may provide an ingredient batch number or code (which may be machine readable) and which may be read to link to the supplier's validated block such that scanning provides the manufacturer 1711 with access to the blockchain 1820. In block 2020, the manufacturer 1711, using at least the supplied raw materials, generates or produces the finished product 1712. As part of the production, one or more sensors 1865 read and report data related to the chemical reaction, or other operation, that results in the finished product 1712. The reported data may be added manually, or automatically through operation of processor 1850, to a block that will contain sensor readouts and other data related to the chemical reaction or other operation. Note that the manufacturer's (validated) block will link back to the supplier's validated block through the header to the manufacturer's validated block. The manufacturer 1711 may add an additional batch number or code (block 2030) to the finished product 1712 through the operation of block 2040. In block 2050, the manufacturer 1711 sends the product 1712 to the distributors 1731. In block 2060, the manufacturer 1711 creates one or more blocks to be validated and added to the blockchain 1820. In block 2070, the manufacturer 1711 multicasts the block. That is, the manufacturer 1711 provides the block to one or more entities (the “participating entities”) shown in FIG. 22. In block 2070, the participating entities validate the received multicast block and once the block is validated, add the validated block to their local blockchain copy. As one alternative, only a sending entity (e.g., a manufacturer 1711) validates the block. In another alternative, the sending and receiving entities each validate the block, and for the block to be retained in the blockchain 1820, both validations must agree. In an aspect, an unvalidated block may be added to the blockchain 1820, but will be deleted if not validated within a specified time, or before a next block addition to the blockchain, whichever condition comes first. The manufacturer's batch code, when scanned, may provide other entities with access to the blockchain 1820 and the specific manufacturer's validated block or blocks, and their associated data. Since the blockchain 1820 is a permissioned blockchain, only the intended distributors 1731 may be designated to receive a multicast of the manufacturer's block. Once a distributor 1731 has validated the manufacturer's block, that block may be added to the local copy of the blockchain 1820 maintained by the distributor. Alternately, all distributors 1731 may receive and validate the block, and add the validated block to their local copy of the blockchain 1820. In a variation, some distributors 1731 may receive and validate the block, but may not be able to access all data within the validated block. Following block validation, operation 2000 ends, block 2080.

The preceding disclosure refers to flowcharts and accompanying descriptions to illustrate the system, component, and device examples represented in FIGS. 2A-15, and 21-23. The disclosed devices, components, and systems contemplate using or implementing any suitable technique for performing the steps illustrated. Thus, the flowcharts of FIGS. 16-20, 24, and 25 are for illustration purposes only and the described or similar steps may be performed at any appropriate time, including concurrently, individually, or in combination. In addition, many of the steps in the flow chart may take place simultaneously and/or in different orders than as shown and described. Moreover, the disclosed systems may use processes and methods with additional, fewer, and/or different steps.

Examples disclosed herein can be implemented in digital electronic circuitry, or in computer software, firmware, or hardware, including the herein disclosed structures and their equivalents. Some examples can be implemented as one or more computer programs; i.e., one or more modules of computer program instructions, encoded on computer storage medium for execution by one or more processors. A computer storage medium can be, or can be included in, a computer-readable storage device, a computer-readable storage substrate, or a random or serial access memory. The computer storage medium can also be, or can be included in, one or more separate physical components or media such as multiple CDs, disks, or other storage devices. The computer readable storage medium does not include a transitory signal.

The herein disclosed methods can be implemented as operations performed by a processor on data stored on one or more computer-readable storage devices or received from other sources.

A computer program (also known as a program, module, engine, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

We claim:

1. A system for processing a waste stream containing organic wastes in a mixture of liquids and solids, the system, comprising:
a pre-processing stage comprising one or more pre-processing components configured to remove at least a portion of the solids from the waste stream;
a centrifugal separator stage comprising one or more centrifuge components configured to separate remaining solids in the waste stream from liquids in the waste stream following the pre-processing stage;
a component sensor system comprising one or more sensors configurable to receive component operational data from system components;
a waste stream sampling system configurable to collect and analyze samples of the mixture of liquids and solids in the waste stream; and
a processing system comprising one or more processors and a non-transitory, computer-readable storage medium having machine instructions encoded thereon, wherein a processor executes the machine instructions to:
receive sensed component operational data and analyses of the samples,
generate a waste stream processing progress measure by applying sensed component operational data and the analyses of the samples to a control program, the control program defining a desired level of waste stream processing, and
process the waste stream until the desired level of waste stream processing is achieved, wherein the processor provides operation adjustments directly to individual components based on a current measure of processing.

2. The system of claim 1, wherein the waste stream is generated by a meat processing facility, the system further comprising:
a solids recovery system that stores the solids separated from the waste stream; and
a liquid recovery system that receives, stores, samples, and processes separated liquids, wherein the processor further executes the machine instructions to:
configure the sensor system to sense the component operational data based on an expected nature and composition of the waste stream, and
configure the sampling system to obtain and analyze the samples of the mixture of the liquids and solids in the waste stream based on the expected nature and composition of the waste stream,.

3. The system of claim 2, wherein the liquid recovery system comprises:
a liquid disposal system, wherein the processed separated liquids are freely released into a natural environment; and
a liquid recycling system, wherein the processed separated liquids are returned to the meat processing facility.

4. The system of claim 2, further comprising a solids recycling and reuse system that receives separated stored solids and produces environmentally acceptable products by processing the stored solids.

5. The system of claim 1, wherein the control program comprises local component control programs for one or more local components, wherein a local component control program comprises local component control instructions and a mapping of individual components of the system, the individual components comprising a control station, a plurality of individual waste stream processing and flow control components, component sensors for one or more of the individual components, and one or more sampling stations, wherein one or more of the individual components comprises a local processing unit, wherein the local processing unit comprises a local processor and the local component control program, wherein the local processing unit is configured for two-way communication with the control station, and wherein the local processing unit receives sensed data from an associated local component, processes the sensed data, adjusts operation of the associated local component based on the sensed data and the local component control program, and provides operational adjustments and sensed data to the control station.

6. The system of claim 5, wherein the local processor executes the local component control program to achieve a desired level of solids removal from the waste stream within a configurable time limit.

7. The system of claim 5, wherein the local processor executes the local component control program to achieve a desired level of biologics in the waste stream and to achieve a desired chemical state of the waste stream.

8. The system of claim 7, wherein the local processor generates a time-varying comparison of a time-varying predicted biologics level and a time-varying predicted chemical state to a time-varying sampled biologics level and a time-varying sampled chemical state, and alters execution of the local component control program based on the time-varying comparison.

9. The system of claim 8, wherein local processor provides the time-varying comparison for display, to a human operator of the system, on a graphical user interface.

10. A computer-controlled system for processing a waste stream comprising liquids and solids, the system, comprising:
one or more processors;
a non-transitory, computer-readable storage medium comprising machine instruction for execution by a processor to invoke a large language model (LLM)-based control program to remotely sense, analyze, and control the system;
an intake component that receives the waste stream and executes, under control of the processor, a pre-processing operation to remove at least a portion of the solids in the waste stream;
a centrifugal separator stage configured and controlled by the processor to separate solids, remaining in the waste stream following the pre-processing operation, from liquids in the waste stream;
a solids recovery system that stores separated solids; and
a liquid recovery system that receives, stores, and, under control of the processor, processes the separated liquids, wherein the processor applies the LLM-based control program to components of a waste stream processing facility, wherein the LLM-based control program comprises individual component control instructions and a mapping of individual components of the system, the individual components comprising a plurality of individual waste stream processing and flow control components, component sensors for one or more of the individual components, and one or more sampling stations.

11. The system of claim 10, wherein the liquid recovery system comprises a liquid disposal system, and a liquid recycling system.

12. The system of claim 10, further comprising a solids reuse system that receives the stored solids and, under control of the processor, produces environmentally acceptable products by processing the solids.

13. The system of claim 10, further comprising, downstream the intake component, one or more heaters, one or more strainers, and one or more vertical decanters.

14. The system of claim 10, wherein one or more of the individual components comprises a local processing unit, wherein the local processing unit comprises a local processor and an LLM-based local component control program stored as machine instructions on a non-transitory, computer-readable storage medium, wherein the local processing unit is configured for two-way communication with a central control station, and wherein the local processing unit receives sensed data from an individual local component, processes the sensed data, adjusts operation of the individual local component based on the sensed data and the LLM-based local component control program, and provides operational adjustments and sensed data to the central control station.

15. The system of claim 14, further comprising:
the local processor unit providing prompted queries to an LLM, the prompted queries comprising operational data related to the local component;
in reply to the query, the LLM, under control of the local processor unit, providing a response in machine readable text; and
the local processor unit executing the machine readable text to adjust operation of the local component.

16. The system of claim 15, further comprising the local processing unit formulating the prompted query in a natural language readable by the LLM.

17. The system of claim 15, further comprising the local processing unit providing the prompted query, the response, and a corresponding operation adjustment to the central control station for archiving.

18. A waste stream processing method, comprising:
a processor initiating a waste stream processing operation, comprising:
initiating a component sensor system by configuring one or more sensors to sense and receive component operational data based on an expected nature and composition of the waste stream, and
initiating a waste stream sampling system by configuring one or more sampling stations to obtain samples of the waste stream based on the expected nature and composition of the waste stream;
the processor receiving and analyzing sensed component operational data and analyzing the samples of the waste stream;
the processor controlling an intake component to execute a pre-processing operation to remove solids in the waste stream;
the processor controlling a centrifugal separator component to separate solids remaining in the waste stream from liquids in the waste stream following the pre- processing operation;
the processor controlling storing of the solids separated from the waste stream;
the processor generating a waste stream processing measure by applying sensed component operational data and analyses of the samples of the waste stream to a component control program; and
processing the waste stream to a desired level of processing, comprising the processor providing real-time operational adjustments directly to local components based on a measured progress toward the desired levels of waste stream processing.

19. The waste stream processing method of claim 18, wherein the component control program is configured to provide operational of one or more local components, wherein the component control program cooperates with a trained, large language model (LLM), wherein a component comprises component sensors, component sampling stations, and a local processor unit, wherein the local processor unit receives sensed data from the component sensors and sample data from the sampling stations, processes the sensed data and the sample data, and adjusts operation of the component based on the sensed data and the sample data.

20. The waste stream processing method of claim 19, further comprising training the LLM using one or more of reinforcement training, supervised training, and unsupervised training.

21. The waste stream processing method of claim 19, further comprising executing the component control program to reach a desired level of solids removal from the waste stream within a configurable time limit.

22. The waste stream processing method of claim 19, further comprising executing the component control program to reach a desired level of biologics in the waste stream and to reach a desired chemical state of the waste stream.

23. The waste stream processing method of claim 18, further comprising recycling stored solids separated from the waste stream to produce environmentally acceptable products.

24. The waste stream processing method of claim 18, wherein the waste stream processing is applied to an effluent waste stream from a meat processing facility, the method further comprising recycling liquids processed from the waste stream, wherein the recycling comprises using the recycled liquids to sanitize the meat processing facility.

25. The waste stream processing method of claim 18, wherein a local processor unit provides prompted queries to an LLM, wherein the LLM provides machine-readable control instructions to the local processor unit, and wherein the local processor unit executes the control instructions to adjust operation of a local component.

26. A waste stream processing system, comprising:
a plurality of waste stream processing components configured to control a chemical state of a waste stream and to remove liquid and solid waste products, biologics, and pathogens, from the waste stream, the waste stream generated by operation of an animal processing facility;
a central processing platform comprising one or more processors executing machine instructions stored on a non-transitory, computer-readable storage medium to initiate, control, and modify a waste stream processing operation based on a nature and a composition of a waste stream;
a network of local processing units distributed in the waste stream processing system and in signal communication with a corresponding waste stream processing system local component and further in signal communication with the one or more processors, wherein each local processing unit comprises a local non-transitory, computer-readable storage medium encoded with machine instructions to sense, record, and transmit signals and data from the corresponding waste stream processing local component, the signals and data indicative of an operational state of the waste stream processing system local component; and
a sampling network of local sampling stations in signal communication with the local processing unit, the local sample stations configured to obtain a local sample of the waste stream and provide corresponding local sample data to one of the local processing units and the central processing platform, wherein the local processing units and the central processing platform cooperate to control local sampling frequency and operation of waste stream processing system local components according to a large language model (LLM) based waste stream processing control program, wherein the operation continues until the waste stream reaches a specified level of processing based on the local samples.

27. The waste stream processing system of claim 26, wherein the local processing unit executes a local sample analysis program for corresponding local sampling stations, wherein the local processing unit executes a comparison of a local sample result with an expected value according to the waste stream processing control program and provides the comparison to the central processing platform.

28. The waste stream processing system of claim 27, wherein the central processing platform signals one or more waste stream processing system local components to alter operation based on the comparison of the local sample result with the expected value according to an LLM-based waste stream processing control program.

29. The waste stream processing system of claim 26, wherein the central processing system applies the LLM to modify the waste stream processing control program for future applications to waste stream processing operations.

30. The waste stream processing system of claim 26, wherein the LLM is trained using expert-provided feedback and machine learning algorithms.
